(19) United States
(12) Patent Application Publication
(10) Pub. No.: US 2020/0226407 A1
(43) Pub. Date: Jul. 16, 2020

(54) DELIVERY OF DIGITAL CONTENT CUSTOMIZED USING IMAGES OF OBJECTS

(71) Applicant: ROK Mobile International Ltd., Culver City, CA (US)

(72) Inventor: Jonathan Kendrick, Culver City, CA (US)

(21) Appl. No.: 16/249,669

(22) Filed: Jan. 16, 2019

(51) Int. Cl. G06K 9/32; G06K 9/00; G06N 20/00

(52) U.S. Cl. CPC G06K 9/3216; G06N 20/00; G06K 9/3241; G06K 9/00201

(57) ABSTRACT

Delivery of digital content based on an image of an object is provided. The digital content can be customized based at least on the object and can include a media asset, such as a still image, an animation, an audio segment, or a video segment. In some embodiments, a computing system can deliver the digital content. To that end, the computing system can receive imaging data from a mobile device. The imaging data represents an image of the object. The mobile device can generate the imaging data in response to execution of an application that permits consuming the digital content. The computing system can detect defined markings on the image, where a first marking of the defined markings has specific semantics. The computing system can select customized digital content based at least on the first marking, and can send the customized digital content to the mobile device.

### BACKGROUND

Providing identification generally entails presenting some form of dedicated card. Similarly, access to restricted areas generally can be accomplished by using a dedicated physical key or portable keycard. In some instances, custom expensive equipment can be utilized to allow a mobile device to be relied upon for access to a restricted area. Not only are the foregoing instruments of identification and access impractical to carry in certain restricted spaces (swimming pools, soccer fields, etc.) but it can be expensive and time consuming to replace them should they be damaged or lost. Further, even when access to a restricted area may be accomplished with more practical instruments, the potential for forging can drastically compromise the reliability of identification and/or access control based on such instruments. These and other shortcomings are addressed herein.

### SUMMARY

It is to be understood that both the following general description and the following detailed description are exemplary and explanatory only and are not restrictive. The present disclosure recognizes and addresses, in at least some embodiments, the issue of monitoring identification and controlling access to a location. Embodiments of the disclosed technologies provide, individually or in combination, identification and access control using wearable tokens. Wearable tokens of various morphologies can be utilized. For example, a wearable token can be embodied in or can include an essentially planar object. As another example, a wearable token can be embodied in or can include a three-dimensional object. The wearable tokens can be customized for a particular live event or a specific bearer of a wearable token. Live events can include, for example, sports event, concerts, weddings, family reunions, cultural events, conferences and trade shows, and the like. Accordingly, in some embodiments, a wearable token can include markings (e.g., arrangements of marks or visual elements) where at least one of the marking can have respective specific semantics.

Regardless the morphology of a wearable token, in some embodiments, a mobile device can initiate execution of an application that presents an instruction to acquire an image of the wearable token. The application can reside in the mobile device and can be installed as either hardware or software. In hardware, as an example, the application can be embodied in or can constitute a dedicated processing integrated circuit, such as an application specific integrated circuit (ASIC) or a field-programmable gate array (FPGA). Such an instruction can be presented in a display device included in the mobile device. As part of execution of the application, the mobile device can acquire the image of the wearable token via a camera module included in the mobile device.

The mobile device can analyze the acquired image to determine if defined markings are present on the image of the wearable token. Thus, in some instances, the mobile device can detect multiple defined markings on the image, where a first marking of the group of defined markings has specific semantics. The first marking can convey, in one example, a name of a live event or a type of the live event. In another example, the first marking can convey a role (such as bouncer, security guard, janitor, on-site contractor, musician, attendee, etc.) linked to the wearable token. A second marking of the group of defined markings detected by the mobile device can convey a unique element that encodes an identity linked to wearable token, such as the identity of a bearer of the wearable token.

In response to at least the first marking, the mobile device can direct an apparatus to perform a defined operation. The apparatus can be remotely located relative to the mobile device and can be untethered to the mobile device. Performance of the defined operation can permit or otherwise facilitate, for example, controlling access to a particular space or navigating within the particular space. In addition, or as an alternative, the mobile device can direct the display device to present the identity linked to the wearable token in response to at least the second marking.

The technologies of this disclosure are not limited to identification and access control using wearable tokens. Some of the technologies can leverage images of objects to provide other services and/or functionalities to a mobile device. The objects can be specific to a service and/or functionality that is provided. While the objects can include wearable tokens, the disclosure is not limited in that respect. The services and/or functionalities can be afforded in response to execution of an application at the mobile device.

Some services can include the delivery of digital content based on an image of an object. The digital content can be customized based at least on the object and can include a media asset, such as a still image, an animation, an audio segment, or a video segment. In some embodiments, a computing system can deliver the digital content. To that end, as an illustration, the computing system can receive imaging data from a mobile device. The imaging data represents an image of the object. The mobile device can generate the imaging data in response to execution of an application that permits consuming the digital content. The mobile device can acquire metadata that can characterize aspect of the operation of the mobile device prior, during, or even after the generation of the imaging data. In some embodiments, the imaging data can include at least some of the metadata acquired by the mobile device. In addition, or in some situations, the mobile device can encrypt the imaging data (whether such data includes metadata or not).

The computing system can analyze the received imaging data. In situations in which the imaging data is encrypted or otherwise secured, the computing system can authenticate the imaging data prior to analyzing the data. Based on the analysis, the computing system can detect a group of defined markings on the image. In addition, or in the alternative, the computing system also can identify a form of the object based at least on the analysis. The computing system can select digital content based at least partially on the group of markings and the identified form, individually or in combination. In some embodiments, the computing system also can utilize a configuration of a user account linked to the mobile device and/or the service provided by the application to select the digital content. In some instances, the computing system also can utilize metadata acquired by the mobile device as a basis for the selection of digital content.

The computing system can send such customized digital content to the mobile device. In some situations, the computing system can leverage current configuration of the user account to determine if the customized digital content can be delivered to the mobile device.

Additional features or advantages of the disclosure will be set forth in part in the description which follows, and in part will be apparent from the description, or may be learned by practice of this disclosure. The advantages of the disclosure can be realized and attained by means of the elements and combinations particularly pointed out in the appended claims. It is to be understood that both the foregoing general description and the following detailed description are exemplary and explanatory only and are not restrictive of the subject disclosure.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 illustrates an example of an operational environment for access control and identification monitoring, in accordance with one or more embodiments of the disclosure.

FIG. 2A illustrates an example of an application module for access control and identification monitoring, in accordance with one or more embodiments of the disclosure.

FIG. 2B illustrates an example of a mobile device for access control and identification monitoring, in accordance with one or more embodiments of the disclosure.

FIG. 3 illustrates another example of an operational environment for access control and identification monitoring, in accordance with one or more embodiments of the disclosure.

FIG. 4 illustrates an example of an operational environment for access to customized digital content based at least on images of objects, in accordance with one or more embodiments of the disclosure.

FIG. 4A illustrates an example of a user interface (UI) that can be presented in response to execution of an application to access customized digital content based at least on an image of an object, in accordance with one or more embodiments of the disclosure

FIG. 4B schematically depicts acquisition of an image of an object by a mobile device, in accordance with one or more embodiments of the disclosure.

FIG. 4C illustrates an example of a UI that can be presented in response to a validated image of an object, in accordance with one or more embodiments of the disclosure.

FIG. 4D illustrates an example of another UI that can permit consuming digital content at a mobile device, in accordance with one or more embodiments of the disclosure.

FIGS. 5-7 illustrate respective examples of a method for providing identification and controlling access using a wearable token, in accordance with one or more embodiments of this disclosure.

FIG. 8 illustrates a method for transferring imaging data from a mobile device to a server device, in accordance with one or more embodiments of the disclosure.

FIG. 9 illustrates an example of a method for securing imaging data generated by a mobile device, in accordance with one or more embodiments of this disclosure.

FIGS. 10-12 illustrate respective examples of a method for delivering digital content customized based at least on images of objects, in accordance with one or more embodiments of this disclosure.

FIG. 13 illustrates an example of a computing environment in accordance with one or more embodiments of the disclosure.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

The methods and systems disclosed herein may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

As is described in greater detail below, embodiments of the present disclosure include devices, techniques, and computer program products that, individually or in combination, permit using wearable tokens for identification and access control. In some embodiments, a mobile device can initiate execution of an application that presents an instruction to acquire an image of a wearable token. The mobile device can be embodied in, for example, a laptop computer, a smartphone, a portable videogame terminal, or any other type of mobile user device. As part of execution of the application, the mobile device can acquire the image of the wearable token by means of a camera module included in the mobile device. In some instances, the mobile device can detect a group of defined markings on the image of the wearable token, where a first marking of the group of defined markings has specific semantics. A second marking of the group of defined markings detected by the mobile device can convey a unique element that encodes an identity linked to wearable token, such as the identity of a bearer of the wearable token.

In response to at least the first marking, the mobile device can direct an apparatus to perform a defined operation. Performing the defined operation can permit or otherwise facilitate, for example, controlling access to a particular space or navigating within the particular space. In addition, or as an alternative, the mobile device can direct the display device to present the identity linked to the wearable token in response to at least the second marking.

Although some embodiments of the disclosure are illustrated herein with reference to wearable token that includes a removable tattoo, the disclosure is not limited in that respect. Indeed, the principles and practical elements of the disclosure can be implemented for other types of wearable tokens, such as a patch, a t-shirt, a sports event bib, a badge, an ornament, and the like.

As further described below, the disclosure also provides delivery of digital content based on an image of an object. The digital content can be customized based at least on the object and can include a media asset, such as a still image, an animation, an audio segment, or a video segment. In some embodiments, a computing system can deliver the digital content. To that end, the computing system can receive imaging data from a mobile device. The imaging data represents an image of the object. The mobile device can generate the imaging data in response to execution of an application that permits consuming the digital content. The computing system can detect defined markings on the image, where a first marking of the defined markings has specific semantics. The computing system can select customized digital content based at least on the first marking, and can send the customized digital content to the mobile device.

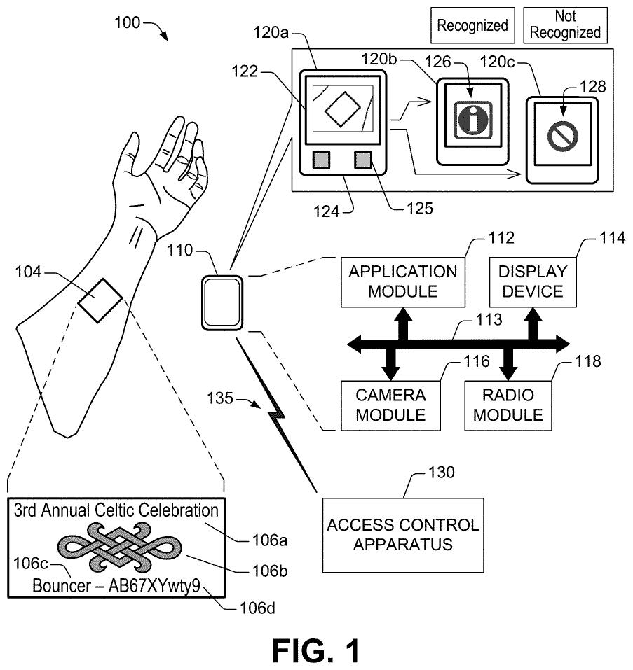

With reference to the drawings, FIG. 1 illustrates an example of an operational environment 100 for access control and/or identification monitoring using a wearable token, in accordance with one or more embodiments of the disclosure. The operational environment 100 includes a mobile device 110 that can acquire an image of a removable tattoo 104 (or, in some embodiments, another type of wearable token). Based at least on the image, the mobile device 110 can control access and/or monitor identification of a bearer of the removable tattoo 104. While the mobile device 110 is generically depicted as a tablet computer, the disclosure is not limited to such a type of device. Elements of the functionality of the operational environment 100 and other environments can be implemented in other types of user devices, such as a laptop computer, a smartphone, a portable videogame terminal, and other types of mobile user devices.

More concretely, the mobile device 110 can initiate execution of an application resident in the mobile device 110. The application can be embodied in or can constitute, for example, an application module 112. The application can be installed in the mobile device 110 as hardware, software, or a combination of both. The execution of the application can cause a display device 114 integrated into the mobile device 110 to display an instruction to acquire an image of a wearable token, such as the removable tattoo 104. For example, as is illustrated in FIG. 1, the display device 114 can present a user interface (UI) 120a that includes a first visual element 124 that embodies or otherwise conveys such an instruction. The UI 120a also includes a second visual element 122 that serves as a viewport to acquire the image. The UI 120a further includes a third visual element 125 that permits or otherwise facilitates confirming the acquisition of the image.

In some embodiments, the first visual element 124 can be selectable. Selection of the first visual element 124 can cause a camera module 116 integrated into the mobile device 110 to acquire a picture of the removable tattoo 104 (or, in some embodiments, another wearable token). The camera module 116 can acquire images within a portion of the electromagnetic radiation spectrum that is visible to the human eye. The camera module 116 also can acquire images outside such a portion of the electromagnetic radiation spectrum, including infrared and/or ultraviolet portions. The camera module 116 can include lenses, filters, and/or other optic elements; one or more focusing mechanisms; and imaging sensor devices that permit capturing both still pictures and motion pictures. The imaging sensor devices can include one or more photodetectors (an array of photodiodes, for example), active amplifiers, and the like. In some embodiments, the imaging sensor devices can be embodied in or can include a semiconductor-based sensor having multiple semiconducting photosensitive elements. For instance, the imaging sensor devices can be embodied in or can include a charge-coupled device (CCD) camera; an active-pixel sensor or other type of complementary metal-oxide semiconductor (CMOS) based photodetector; an array of multi-channel photodiodes; a combination thereof; or the like.

In some scenarios, acquiring the image of the removable tattoo 104 can include generating multiple image frames that can be processed by the mobile device 110 to produce a single image. For instance, the multiple frames can constitute a 360-degree scan of a wearable token, such as the removable tattoo 104, which scan can permit a detailed analysis of the wearable token. Such a scan can be implemented, for example, in embodiments in which the wearable token includes a three-dimensional (3D) structure rather than a slab or another type of essentially planar object.

As is illustrated in FIG. 1, the wearable tattoo 104 can include several markings, e.g., distinct arrangements of visual elements or indicia. Each one of the several markings has a specific structure, including shape and color, for example. One or more of the several markings also can include respective content. Thus, one or more of such markings can have respective semantics. For example, a first marking of the defined markings can include a legend or another type of inscription. As another example, a second marking of the defined markings can include a logo or another type of graphical representation of an entity. In addition, two or more markings can be related to a particular theme and/or a particular live event. The particular live event can include a sports event, a cultural event, a conference, a trade show, a family reunion, a wedding, a birthday celebration, or the like. As an example, the removable tattoo 104 can include first indicia 106a and second indicia 106b related to a specific live event—a Celtic celebration. As is illustrated in FIG. 1, the first indicia 106 includes natural language and the second indicia includes an image. The removable tattoo 104 also can include other types of markings that can personalize the removable tattoo 104. Specifically, such markings include third indicia 106c indicative of a specific function linked to the wearable tattoo 104 (or the bearer thereof). The markings also can include fourth indicia 106d indicative of a unique code linked to the wearable tattoo 104.

Accordingly, upon or after the mobile device 110 acquires the image of the wearable tattoo 104 (or, in some embodiments, another type of wearable token) the mobile device 110 can determine if a group of defined markings is present in the acquired image. The group of defined markings can include specific text; one or more specific graphical marks; or a combination of the specific text and at least one of the specific graphical mark(s). The specific text can include separate, individual characters, without express meaning individually. In addition, or as an alternative, the specific text can include words, phrases, legends, passages, or a combination thereof. Such characters can include letters, numbers, special characters, or a combination thereof. A special character can have, in some instances, semantic meaning, such as it may be the case for a character in a foreign language.

The group of defined markings can establish, for example, a specific scope of access to be afforded to the wearable tattoo 104 (or a bearer thereof). The specific scope of access can include, for example, location(s) to which the wearable tattoo is permitted to enter; time period(s) during which the wearable tattoo is permitted to access a defined location; in-and-out privileges in a location; and the like. Various types of locations are contemplated. For instance, the locations can include a loyalty club lounge, backstage at a concert or entertainment event, clubhouse access, and the like.

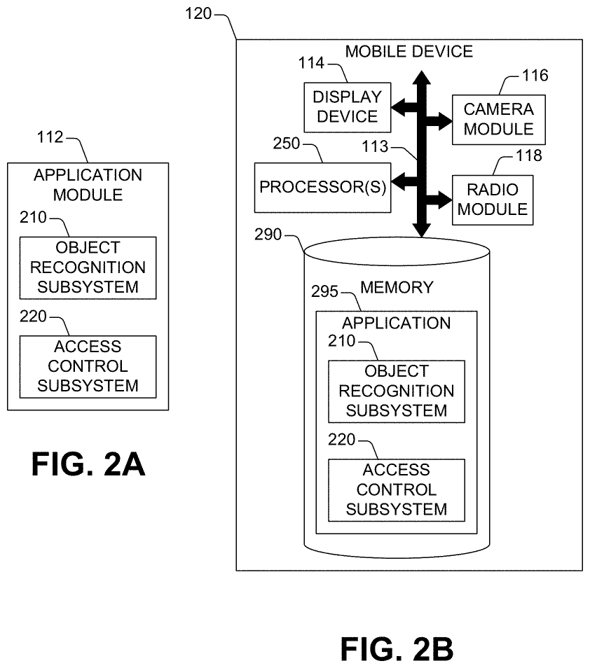

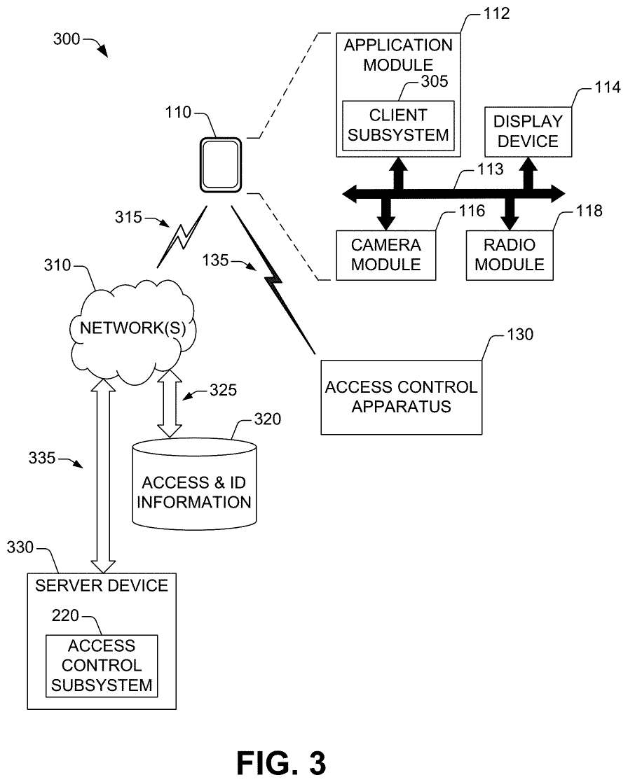

To perform such a determination, the mobile device 110 can execute (or, in some instances, can continue executing) the application retained in the application module 112. In some embodiments, as is illustrated in FIG. 2A, the application module 112 can include an object recognition subsystem 210 that can determine if the group of defined markings are present in the acquired image. The object recognition subsystem 210 constitutes the application resident in the mobile device 110. In other embodiments, as is illustrated in FIG. 2B, the application module 112 can be embodied in computer-accessible instructions can be encoded or otherwise retained in one or more memory devices 290 (generically represented as memory 290). The computer-accessible instructions also can be encoded or otherwise retained in other types of computer-readable non-transitory storage media. The computer-accessible instructions include computer-readable instructions, computer-executable instructions, or a combination of both, that can be arranged in one or more components. The component(s) can be built (e.g., linked and compiled) into an application 295 that can be executed by one or more processors 250 in order to provide the various functions described herein. To that point, the application 295 includes the object recognition subsystem 210.

With further reference to FIG. 1, in one scenario, the application can detect the group of defined markings in the image of the removable tattoo 104 (or another type of wearable token that is imaged in accordance with this disclosure). To detect the group of defined markings the mobile device 110 can execute (or, in some instances, can continue executing) the application to perform one or multiple machine-vision techniques that can identify at least one marking of the defined markings. Such techniques can include, edge detection, segmentation, and the like. In addition, or as an alternative, the mobile device 110 can execute (or, in some instances, can continue executing) the application to apply a machine-learning model to the image of the removable tattoo. The machine-learning model is trained to identify each one of the defined markings. The machine-learning model can be embodied in or can include, for example, a support vector machine (SVM), a regression model (such as a k-nearest neighbor (KNN) model); a neural network (NN), a convolutional neural network (CNN); a region-based CNN (R-CNN); a generative adversarial network (GAN); or the like. Parameters that defined the machine-learning model can be determined (or, in machine-learning parlance, trained) by solving a defined optimization problem, using a training data in a supervised or unsupervised fashion. The training data includes example images of a particular defined marking, such as a legend or inscription; a graphical mark; an emblem; a symbol; a brand name; a band name; an event name; a venue name; a font type; or the like. In some embodiments, as is shown in FIG. 2A and FIG. 2B, the machine-vision technique and/or the machine-learning model can be encoded or otherwise retained in the object recognition subsystem 210.

More specifically, the object recognition subsystem 210 can detect a defined marking (e.g., an arrangement of marks, such as an image or a text) in two-dimensional (2D) images of respective wearable tokens. As mentioned, wearable tokens can be embodied in or can include essentially planar objects or 3D objects having respective morphologies. A morphology of an object includes a shape of the object, a material or combination or materials that constitute the object, and internal structure of the object. The internal structure can include, for example, an arrangement of voids and/or an arrangement of overlays of respective sizes. Similar to other wearable tokens of this disclosure, the morphology can be specific to a live event and/or an intended bearer a wearable token.

The object recognition subsystem 210 can analyze properties of a 2D image to determine (or, in machine-vision parlance, recognize) various properties of the wearable token regardless of the wearable token being essentially planar or non-planar. The properties of the wearable token can include, for example, shape, texture or other structure; color; inscription(s) (and subsequent optical character recognition (OCR)); inscription positioning within the wearable token; images present on the wearable token, scannable codes (e.g., QR codes, bar codes, etc.); non-scannable codes; a combination of the foregoing; and the like.

The object recognition subsystem 210 also can identify a form of three-dimensional wearable token in an image acquired by the mobile device 110, via the camera module 116, for example. Such a 3D reconstruction can be performed by establishing a machine-learning shape model, which can be referred to as a trained feature model. Such a machine-learning shape model can be determined (or, in machine-learning parlance, trained) from training data where the 2D-3D correspondence is known, by estimating parameters that define the shape model. The parameters can be estimated by solving a model-specific optimization problem, for example. More concretely, such a machine-learning shape model can be trained by generating multiple image of a three-dimensional wearable token and determining model parameters using at least such images. More specifically, upon or after acquiring an image of a wearable token that is embodied in a 3D object (e.g., an ornament, a talisman, or another type of small sculpture), the process of identifying a form of the 3D object can include a two-stage process. In a first stage, image features, such as points, curves, and contours, are identified in the images. The features can be identified using various techniques, including Active Shape Models (ASM), gradient-based methods, or classifiers such as SVM. In a second stage, in some embodiments, the form is inferred using a trained feature model. In other embodiments, the second stage can include extending the 3D shape representation from curves and points to a full surface model by fitting a surface to the 3D data.

Without intending to be bound by theory and/or modeling, generation of a feature model is described. Assume a number of elements in a d-dimensional vector t, for example, a collection of 3D points in some normalized coordinate system. The starting point for the derivation of the model is that the elements in t can be related to some latent vector u of dimension q where the relationship is linear:

t=Wu+μ (1)

where W is a matrix of size d×q and μ is a d-vector allowing for non-zero mean. Once the model parameters W and μ have been learned from examples, they are kept fixed. However, measurements take place in the images, which usually is a non-linear function of the 3D features according to the projection model for the relevant imaging device.

Denote the projection function with f: R^{d}→R^{e}, projecting all 3D features to 2D image features, for one or more images. Also, the coordinate system of the 3D features can be changed to suit the actual projection function. Denote this mapping by T: R^{d}→R^{d}. Typically, T is a similarity transformation of the world coordinate system. Thus, f(T(t)) will project all normalized 3D data to all images. Finally, a noise model needs to be specified. Assume that the image measurements are independent and normally distributed, likewise, the latent variables are assumed to be Gaussian with unit variance u˜N(0,1). Thus, in summary:

t_{2D}=f(T(t)+ϵ=f(T(Wu+μ))+ϵ (2)

where ϵ˜N(0, σ² I) for some scalar σ.

Before the model can be used, parameters of the model need to be estimated from training data. Given that it is a probabilistic model, in some embodiments, the parameters can be determined by solving an optimization problem, such as finding a maximum likelihood (ML). Assume n examples {t_{2D,i}}ᵢ₌₁ⁿ, the ML estimate for W and μ is obtained by minimizing:

$${\sum }_{i = 1}^{n} ( \frac{1}{{σ}^{2}} {‖ {t}_{2 D} - f ( {T}_{i} ( {u}_{i} ) ) ‖}^{2} + {‖ {u}_{i} ‖}^{2} \qquad ( 3 )$$

over all unknowns. The standard deviation a is estimated a priori from the data. After the model parameters W and μ have been learned from examples, they are kept fixed. In practice, to minimize (3) the methods can alternatively optimize over (W, μ) and {uᵢ}ᵢ₌₁ⁿ using gradient descent. Initial estimates can be obtained by intersecting 3D structure from each set of images and then applying PPCA algorithms for the linear part. The normalization Tᵢ(.) is chosen such that each normalized 3D sample has zero mean and unit variance.

There are three different types of geometric features embedded in the model, points, curves, and apparent contours. Points: A 3D point which is visible in m>1 images will be represented in the vector t with its 3D coordinates (X,Y,Z). For points visible in only one image, m=1, no depth information is available, and such points are represented similarly to apparent contour points. Curves: A curve will be represented in the model by a number of points along the curve. In the training of the model, it is important to parameterize each 3D curve such that each point on the curve approximately corresponds to the same point on the corresponding curve in the other examples. Apparent contours: As for curves, we sample the apparent contours (in the images). However, there is no 3D information available for the apparent contours as they are view-dependent. A simple way is to treat points of the apparent contours as 3D points with a constant, approximate (but crude) depth estimate.

Finding Image Features.—In the on-line event of a new input sample, we want to automatically find the latent variables u and, in turn, compute estimates of the 3D features t. The missing component in the model is the relationship between 2D image features and the underlying grey-level (or color) values at these pixels. There are several ways of solving this, e.g. using an ASM (denoted the grey-level model) or detector based approaches.

The Grey-Level Model.—Again, a linear model (PPCA) can be adopted. Using the same notation as in Eq. (1), but now with the subscript gl for grey-level, the model can be written

t_{gl}=W_{gl}u_{gl}+μ_{gl}+ϵ_{gl} (4)

where t_{gl} is a vector containing the grey-level values of all the 2D image features and ϵ_{gl} is Gaussian noise in the measurements. In the training phase, each data sample of grey-levels is normalized by subtracting the mean and scaling to unit variance. The ML-estimate of W_{gl} and μ_{gl} is computed with the EM-algorithm [5].

Detector-Based Methods.—Image interest points and curves can be found by analyzing the image gradient using e.g. the Harris corner-detector. Also, specially designed filters can be used as detectors for image features. By designing the filters so that the response for certain local image structures are high, image features can be found using a 2D convolution.

Classification Methods.—Using classifiers, such as SVM, image regions can be classified as corresponding to a certain feature or not. By combining a series of such classifiers, one for each image feature (points, curves, contours etc.) and scanning the image at all appropriate scales the image features can be extracted. Examples can include, for example, an eye detector for facial images.

Deformable Models.—Using a deformable model such as the Active Contour Models, also called snakes, of a certain image feature is very common in the field of image segmentation. Usually the features are curves. The process is iterative and tries to optimize an energy function. An initial curve is deformed gradually to the best fit according to an energy function that may contain terms regulating the smoothness of the fit as well as other properties of the curve.

Surface Fitting to the 3D Data.—After the 3D data is recovered, a surface model can be fitted to the 3D structure. This might be desirable in case the two-step procedure above only produces a sparse set of features in 3D space such as e.g. points and space curves. Even if these cues are characteristic for a particular sample (or individual), it is often not enough to infer a complete surface model, and in particular, this is difficult in the regions where the features are sparse. Therefore, a 3D surface model consisting of the complete mean surface is introduced. This will serve as a domain-specific, e.g., specific for a certain class of objects, regularizer. This approach requires that there is dense 3D shape information available for some training examples in the training data of the object class obtained from e.g. laser scans or, in the case of medical images, from MRI or computer tomography, for example. From these dense 3D shapes, a model can be built separate from the feature model above. This means that, given recovered 3D shape, in the form of points and curves, from the feature model, the best dense shape according to the recovered 3D shape can be computed. This dense shape information can be used to improve surface fitting.

Regardless of the technique(s) utilized, the detection of the group of defined markings in the image of the removable tattoo 104 (or another type of wearable token that is imaged in accordance with this disclosure) can cause the display device 114 to present information based at least on one or more markings of the group of defined markings. The information presented by the display device 114 can permit or otherwise facilitate identifying a bearer of the removable tattoo 104 (or another type of wearable token that is imaged in accordance with aspects of this disclosure). In addition, or in other instances, the information can permit or otherwise facilitate controlling access to a specific area. As is illustrated in FIG. 1, the display device 114 can present a UI 120b having a group of visual elements 126 that convey the information. In addition, or in other embodiments, the mobile device 110 can present aural elements that convey at least some of the information. To that end, the mobile device 110 can include an audio output module (not depicted in FIG. 1).

The information that is presented by the display device 114 can be generated or otherwise accessed in multiple ways. In some embodiments, the mobile device 110 can execute (or, in some instances, can continue executing) the application retained in the application module 112 to generate the information. To that end, in one example, the application can generate the information by applying access control logic to the one or more markings that are detected on an image of the removable tattoo 104 (or another type of wearable token). Again, with reference to FIG. 2A, in some embodiments, the application module 112 can include an access control subsystem 220 that can apply the access control logic. The access control subsystem 220 constitutes the application resident in the mobile device 110. In other embodiments, as is illustrated in FIG. 2B, the application module 112 can be embodied in computer-accessible instructions encoded or otherwise retained in the memory 290. The computer-accessible instructions also can be encoded or otherwise retained in other types of computer-readable non-transitory storage media. As mentioned, the computer-accessible instructions include computer-readable instructions, computer-executable instructions, or a combination of both, that can be arranged in one or more components. The component(s) can be built (e.g., linked and compiled) into the application 295 that can be executed by the processor(s) 270 in order to provide the various functions described herein. To that point, the application 295 includes the object recognition subsystem 210 and the access control subsystem 220.

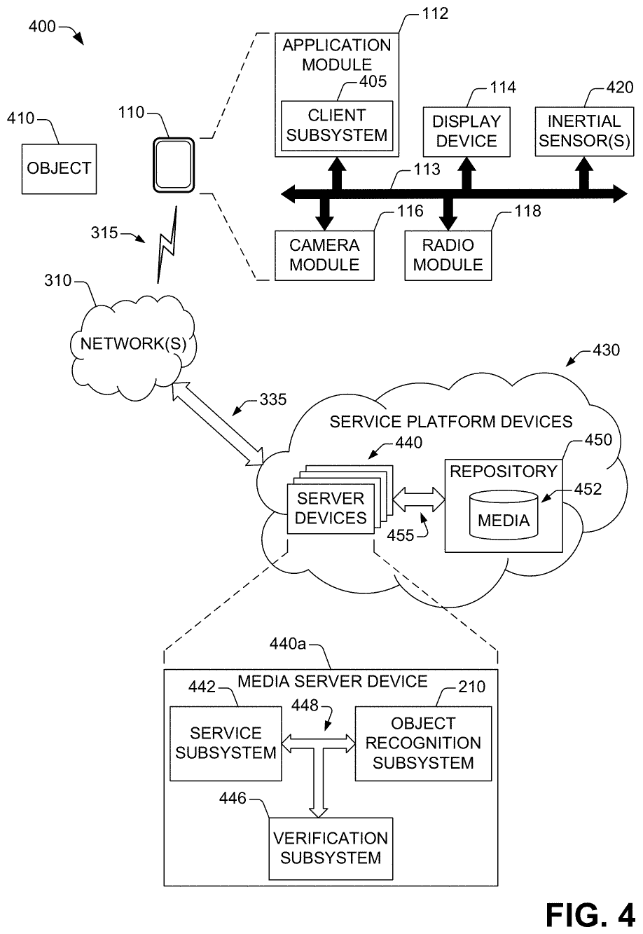

The access control logic can include one or more access rules and can be retained in one or more memory devices (not depicted in FIG. 1) integrated into the mobile device 110. For instance, a first access control rule can dictate that a name and/or a picture of an individual identified by a marking detected in the removable tattoo be accessed. As such, the application can apply the first access rule to each of the markings in the detected group of markings. As a result, the application can access the name and/or imaging data indicative of a picture of the individual when a first markings identifies the individual. More concretely, as an illustration, in connection with the removable tattoo 104, the application can access a name and a picture from the fourth indicia 106d. Thus, by applying the first access rule, the application can cause the display device 114 to present the name (e.g., Joe B. Sepz) and picture. Accordingly, the visual elements 126 can include elements that convey the name and also can include the picture. To access such information, in some embodiments, as is illustrated in FIG. 3, the application module 112 can generate a query message requesting the name and picture. The application module 112 can send the query message to a database 320 that contains access and identification (ID) information. The database 320 can send a response message to the query message, to the application module 112, where the response message can include the name and picture.

As is further illustrated in FIG. 3, one or more networks 310 can permit or otherwise facilitate the exchange of the query and response messages and related information between the mobile device 110 and the database 320. To that, at least one of the network(s) 310 can functionally couple the mobile device 110 and the database 320. Such a coupling can be permitted or otherwise facilitated by wireless links 315 and a communication architecture 325. The communication architecture 325 can include upstream links (ULs) and downstream links (DLs). Each one of the ULs and the DLs can be embodied in or can include a wireless link (e.g., deep-space wireless links and/or terrestrial wireless links), a wireline link (e.g., optic-fiber lines, coaxial cables, and/or twisted-pair lines), or a combination thereof. It is noted that while illustrates as separate elements, portions of the communication architecture 325 can be integrated into one or more of the network(s) 310.

The network(s) 310 can include wireline network(s), wireless network(s), or a combination thereof. Each one of the networks that can constitute the network(s) 310 has a defined footprint. As such, the network(s) 310 can include public networks, private networks, wide area networks (e.g., Internet), local area networks, and/or the like. The network(s) 310 can include a packet switched network (e.g., internet protocol based network), a non-packet switched network (e.g., quadrature amplitude modulation based network, plain old telephone system (POTS)), a combination thereof and/or the like. The network(s) 310 can include numerous types of devices, such as network adapter devices, switch devices, router devices, modems, and the like functionally coupled through wireless links (e.g., cellular, radio frequency, satellite) and/or wireline links (e.g., fiber optic cable, coaxial cable, Ethernet cable, or a combination thereof). The network 310 can be configured to provide communication from telephone, cellular, modem, and/or other devices to and throughout the operational environment 300.

Further, or in another example, a second access rule can dictate that information indicative of a locale be accessed for a specific function conveyed by a detected marking. As such, the application retained in the application module 112, when executed, can apply the second rule to each of the markings in a detected group of markings. As a result, the application can access the information indicative of the locale when a first marking identifies a particular function or role. More concretely, in connection with the removable tattoo 104, the application can access location information in response to the third indicia 106d. Such indicia, as mentioned, can link the removable tattoo 104 to a “Bouncer” role. Thus, by applying the second access rule, the application can cause the display device 114 to present information indicative of a location within a venue where the bearer of the removable tattoo 104 is to serve as a bouncer. Accordingly, the visual elements 126 can include elements that convey the location within the venue. Again, to access such information, as is illustrated in FIG. 3, the application module 112 can generate a query message requesting such location information. The application module 112 can send the query message to the database 320. The database 320 can send a response message to the query message, to the application module 112, where the response message can include the location information. As mentioned, one or more networks 310 can permit or otherwise facilitate the exchange of the query and response messages and related information between the mobile device 110 and the database 320.

Therefore, the application retained in the application module 112 can cause the display device 110 to present a name, a picture, and location information in response to applying the first and second access rules to markings including third indicia 106 and fourth indicia 106d. The information present at the display device 114 can permit or otherwise facilitate corroborating that the bearer of the removable tattoo 104 is legitimate and is directed to an appropriate locale.

The access control subsystem 220 (see FIG. 2A and FIG. 2B) need not be configured in the mobile device 110. Instead, in some embodiments, the access control subsystem 220 can be installed or otherwise configured in a server device separate from the mobile device 110. In such embodiments, the mobile device 110 can include a client subsystem that can communicate with the access control subsystem 220 within the other device.

With further reference to FIG. 3, the operational environment 300 includes such a server-client configuration. At least one of the network(s) 310 can functionally couple the mobile device 110 and a server device 330. Such a coupling can be permitted or otherwise facilitated by the wireless links 315 and a communication architecture 335. The communication architecture 335 can include upstream links (ULs) and downstream links (DLs). Each one of the ULs and the DLs can be embodied in or can include a wireless link (e.g., deep-space wireless links and/or terrestrial wireless links), a wireline link (e.g., optic-fiber lines, coaxial cables, and/or twisted-pair lines), or a combination thereof. It is noted that while illustrates as separate elements, portions of the communication architecture 325 can be integrated into one or more of the network(s) 310.

An application included in the application module 112 can detect a group of defined markings in an image of the removable tattoo 104 (or another type of wearable token). The application can send information indicative of the group of defined markings to the access control subsystem 220. The information can be sent via at least one first network of the network(s) 310.

The access control subsystem 220 can receive the information and can apply access control logic in accordance with various aspects of this disclosure. As a result, the access control system 220 can send access control information to a client subsystem 305. The access control information can be sent via the at least one first network. The client subsystem 305 can be included in the application retained in the application module 112. In response to receiving the access control information, the client subsystem 305 can cause the display device 114 to present at least a portion of the access control information. To that point, as mentioned, the display device 114 can present the UI 120 b including visual elements 126 that convey at least the portion of the access control information.

Detection of a group of defined markings in the image of the removable tattoo 104 (or another type of wearable token that is imaged) can cause the mobile device 110 to implement additional or different responses besides displaying information. In some embodiments, with further reference to FIG. 1, the mobile device 110 can cause an access control apparatus 130 to perform a specific operation based at least on one or more of the group of defined markings that is detected. Such an operation can correspond to a specific functionality of the access control apparatus 130. In one instance, the operation can be performed in response to a first marking of the group of defined marking being indicative of a sanctioned live event (e.g., Celtic celebration) or a sanctioned function (e.g., bouncer). In another instance, the operation can be performed in response to first and second markings of the group of defined marking being indicative, respectively, of a validated identity and a sanctioned function. For example, the access control apparatus 130 can be embodied in or can include an automated gate apparatus, and the specific operation can be opening the gate. A gate of such an apparatus can be opened in response to the mobile device 110 detecting the graphical mark in the second indicia 106b and the function conveyed by the third indicia 106d. In other words, the mobile device 110 can determine that the removable tattoo 104 is linked to a bouncer for the 3rd Annual Celtic Celebration and can cause the gate to open.

Thus, in sharp contrast to commonplace technologies for controlling access, embodiments of the subject disclosure provide identification and access control without reliance on expensive devices (carried by an end-user or deployed at a control point). Thus, in further contrast, embodiments of the disclosure can provide identification and access control in environments where it may be impractical or undesirable to carry mobile devices or other consumer electronics.

Regardless the architecture and functionality of the access control apparatus 130, the mobile device 110 can send an instruction to perform the specific operation. The instruction can be formatted or otherwise configured according to a control protocol for the operation of actuators, switches, motors, and the like. The control protocol can include, for example, modbus; Ethernet-based industrial protocol (e.g., Ethernet TCP/IP encapsulated with modbus), controller area network (CAN) protocol; profibus protocol; and/or other types of fieldbus protocols.

The instruction can be sent wirelessly via at least a wireless upstream link (uplink (UL)) included in wireless links 135. To that end, the mobile device can include a radio module 118 than can send the instruction according to a defined radio technology protocol for point-to-point or short-range wireless communication. More specifically, the radio module 118 can include one or more antennas and processing circuitry that permit communicating wirelessly in accordance with the defined radio technology protocol. Thus, the radio module 118 is configured to wireless signals according to one or several radio technology protocols including ZigBee™; Bluetooth™; near field communication (NFC) standards; ultrasonic communication protocols; or the like. The antenna(s) and processing circuitry also can permit the radio module 118 to communicate wirelessly according to other radio technology protocols, including protocols for small-cell wireless communication and macro-cellular wireless communication. Such protocols include IEEE 802.11a; IEEE 802.1 lax; 3rd Generation Partnership Project (3GPP) Universal Mobile Telecommunication System (UMTS) or “3G;” fourth generation (4G); fifth generation (5G); 3GPP Long Term Evolution (LTE); LTE Advanced (LTE-A); wireless broadband (WiBro); and the like.

As mentioned, in some embodiments, a wearable token can be embodied in a 3D object, such as a garment, an ornament, a talisman, a small sculpture, or another type of custom-made 3D object. Some 3D objects also can include other features, such as colors, patterns, and the like. The 3D objects can be formed by means of 3D printing, machining, molding, or other manufacturing techniques. In such embodiments, the mobile device 100 can identify a form of the 3D object; e.g., a bottle, an automobile, a guitar, an emblem, a butterfly, a fairy, a dog, a jack-o-lantern effigy, a pig effigy, and the like. In instances in which the identified form matches a defined form of a reference object, the mobile device 110 can cause the display device 115 to present information in accordance with aspects described herein.

Further, or in some instances, a 3D wearable token can include markings (e.g., characters in relief) representative of a legend, for example. In addition, or as an alternative, the 3D wearable token can include structural features, such as a particular arrangement of overlays (e.g., an array of colored pieces) or a pattern of colors. The mobile device 110 can detect such markings and/or structural features in addition to determining a 3D shape of the 3D wearable token. In response to such a detection, the mobile device 110 can cause the display device 112 to present specific information in accordance with aspects of this disclosure. In addition, or in other instances, the mobile device 110 also can cause the access control apparatus 130 to perform one or more defined operations.

As an illustration, the 3D wearable token can include a small sculpture of a labradoodle dog and an inscription that reads “Ginger N” The mobile device 110 can be utilized at a kennel or boarding facility where the application module 112, via the object recognition 210, for example, can detect such an inscription and shape on the 3D wearable token. In response, the mobile device 110 can cause a display device 112 to present confirmation information that a labradoodle named “Ginger,” with last name initial “N” is scheduled for an overnight stay, and also can present a picture of Ginger. Based on such a determination, the mobile device 110 can cause a variable-sign display apparatus to present visual elements indicative of a kennel room assigned to such a dog and a location of the kennel room within the boarding facility. Further based on such a determination, the mobile device 110 can cause a lock device on a door of the kennel room to become unlocked. Both the variable sign-display and the lock device can constitute the access control apparatus 130.

In some scenarios, the application module 112 (via, for example, the object recognition subsystem 210, FIG. 2A and FIG. 2B) can determine that the group of defined markings is absent from the acquired image of the removable tattoo 104 (or another type of wearable token that is imaged). In response, the mobile device 110 can perform an exception handling process. In some embodiments, as part of performing the exception handing process, the mobile device 110 can cause the display device 114 to present information indicative of the wearable token being in a fault state. As an example, the fault state can represent a denial of access to a facility or another type of premises. Such information can be retained in one or more memory devices (not depicted in FIG. 1) integrated into the mobile device 110. Specifically, the display device 114 can present a UI 120 c having a group of visual elements 128 (text, graphics, etc.) indicative of such information. In addition, or in other embodiments, the mobile device 110 can present a group of aural elements (e.g., utterances or other types of sound) that convey the at least some of the information indicative of the fault-state.

In the foregoing embodiments disclosed in connection with mobile device 110, a communication interface 113 functionally couples the modules, devices, and other components included in the mobile device 110. The communication interface 113 permits the transmission, reception, and exchange of data, metadata, signaling, within the mobile device 110. As such, the communication interface 113 be embodied in or can include, for example, one or more bus architectures or other wireline or wireless connections. One or more of the bus architectures can include an industrial bus architecture, such as an Ethernet-based industrial bus, a controller area network (CAN) bus, a Modbus, other types of fieldbus architectures, or the like. The communication interface 113 can have additional elements, which are omitted for simplicity, such as controller device(s), buffer device(s) (e.g., caches), drivers, repeaters, transmitter device(s), and receiver device(s), to enable communications. Further, the communication interface 113 may include address, control, and/or data connections to enable appropriate communications among the aforementioned components.

Embodiments of the technologies of this disclosure are not limited to identification and access control using wearable tokens. Some embodiments can utilize images of objects to provide other services and/or functionalities to a mobile device. The objects can be specific to a service and/or functionality that is provided. While the objects can include wearable tokens, the disclosure is not limited in that respect.

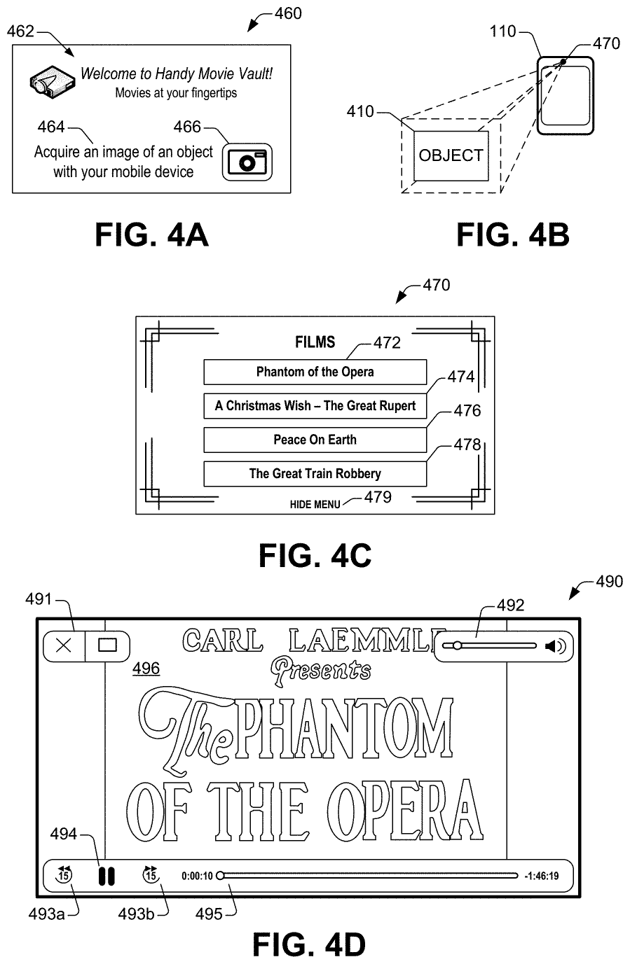

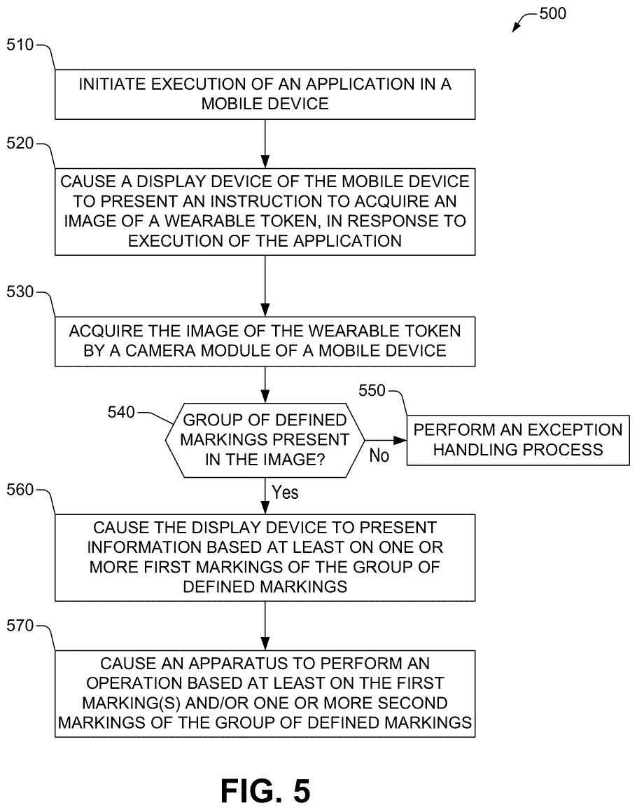

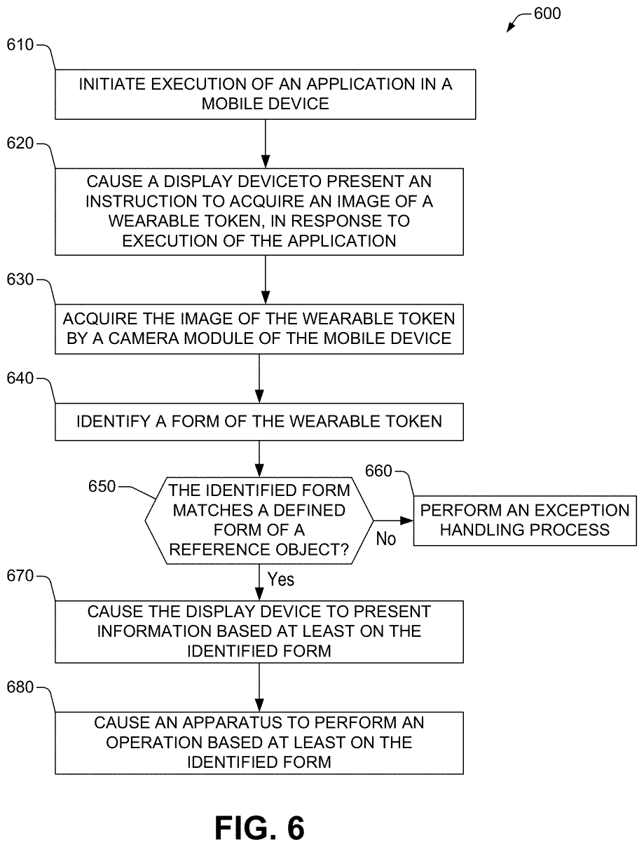

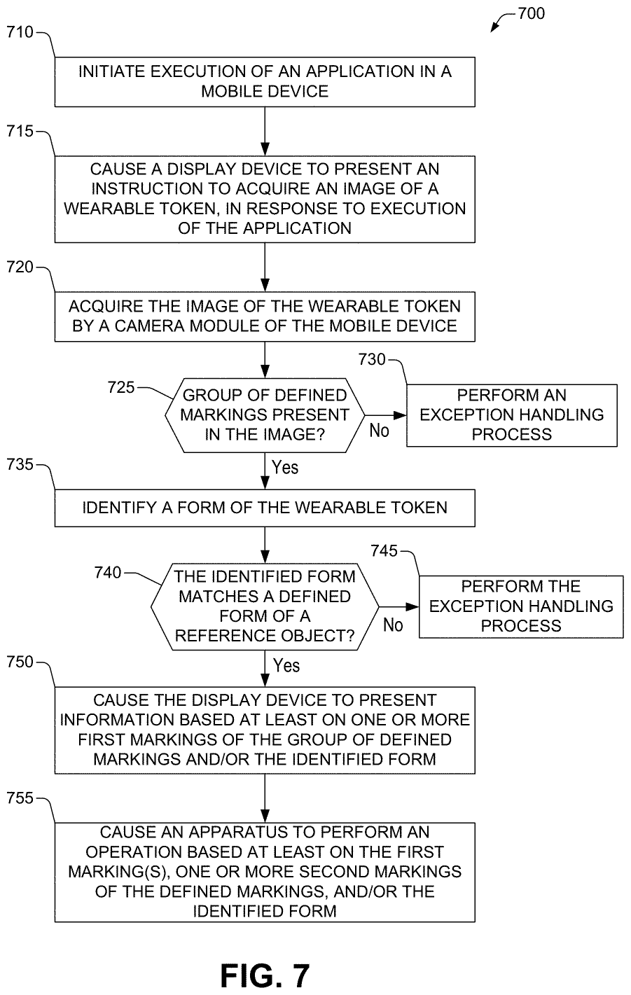

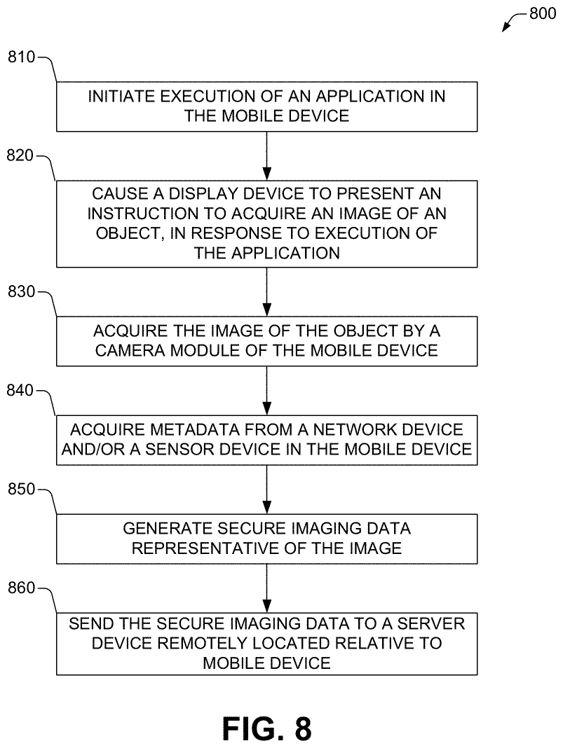

Similar to other embodiments of the disclosure, the mobile device 110 can execute an application retained in the application module 112. In response to execution, such an application can provide specific functionality to the mobile device 110. For example, the service and/or functionality can include the delivery of digital content that is customized based at least on an image of an object. Accordingly, in response to execution, the application can cause the display device 114 to present customized digital content. The mobile device 110 can receive the customized digital content from a network device remotely located relative to the mobile device 110. FIG. 4 illustrates an example of an operational environment 400 to access to customized digital content based at least on images of objects, in accordance with one or more embodiments of the disclosure.

To receive customized digital content, the mobile device 110 can initiate execution of the application. In response, the display device 114 can present an instruction to acquire an image of an object 410. As an example, the object 410 can be embodied in, for example, a currency bill, a wearable token, a talisman, a toy, a 3D token, a consumer electronics device, or the like. In some embodiments, the display device 114 can present a UI including a visual element that conveys the instruction to acquire the image. The visual element can be selectable. Selection of the visual element can cause the mobile device 110 to acquire the image of the object 410. In other embodiments, the UI can include a second visual element that is selectable and, in response to selection, can cause the mobile device 110 to acquire the image. As an illustration, the application retained in the application module 112 can permit receiving and consuming particular movies. Simply for the sake of nomenclature, the application may be referred to as “Handy Movie Vault” application. FIG. 4A depicts an example of a UI 460 that can be presented by the display device 114 in response to execution of the “Handy Movie Vault” application. The UI 460 includes a visual element 462 having multiple indicia that serve to introduce the application and its functionality. It is noted that the functionality of the technologies described herein for accessing customized digital content does not require the presence nor does it require any particular arrangement of indicia in the visual element 462 in order to operate in accordance with aspect described herein.

The UI 460 also includes a second visual element 464 that conveys the instruction to acquire the image of an object (e.g., the object 410). The UI 460 further includes a selectable visual element 466 that, in response to being selected, configures the mobile device 110 to acquire such an image. The particular indicia shown in those elements are merely illustrative. The functionality of the technologies described herein does not require such particular appearance in order to provide access to customized digital content in accordance with aspects of this disclosure. Selection of the selectable visual element 466 can activate or otherwise launch a camera application or other utility software. In some instances, the camera application or such other utility software can cause the camera module 116 to transition from a low-power state (e.g., a power-save state) to a high-power (e.g., power ON state). Such a transition can cause the display device 114 to enter an imaging mode (not depicted in FIG. 4A) that permits acquiring the image of the object 410. As is shown in FIG. 4B, in one example, the camera application or such other utility software can permit acquiring an image of the object 410 via, at least, a lens assembly 470 included in the camera module 116. The lens assembly 470 can permit adjusting the field of view to a region surrounding the object 410. Such a field of view is represented by dashed lines in FIG. 4B.

Again, as part of execution of the application retained in the application module 112, the mobile device 110 can acquire the image of the object 410 in response to such an instruction. The mobile device 110 can acquire the image by means of the camera module 116. As a result, the camera module 116 can generate digital imaging data representative of the image of the object 410. As is disclosed herein, acquiring the image includes generating analog signals representative of the image. Imaging sensor devices included in the camera module can generate the analog signals. In addition, or in some embodiments, acquiring the image also can include converting the analog signals to digital data. One or more digitization components in the camera module 116, for example, can digitize the analog signals. The digital data also represents the image of the object 410. Further, or in yet other embodiments, acquiring the image can include formatting the digital data according to a format for storing digital content. The formatted digital data constitutes imaging data representative of the object.

In some instances, in view of the digital content that may be received based on the image of the object 410, the mobile device 110 can secure the digital imaging data representative of the image in order to prevent or mitigate illegitimate access to the digital content. In other instances, the digital imaging data can be secured in order to safeguard the nature of the image and/or for other privacy reasons. As such, a client subsystem 405 included in the application module 112 can secure the digital imaging data representative of the image. To that end, the client subsystem 405 can operate on the digital imaging data in numerous ways. In some embodiments, for example, the client subsystem 405 can encrypt the digital imaging data using public/private key encryption. The client subsystem 405 also provides the functionality of the client subsystem 305 in accordance with aspects described herein.

To that end, the client subsystem 405 can access a private key. The private key can be retained within an offline memory device or another element of the mobile device 110 as part of a private/public key pair of a cryptosystem associated with the mobile device. In some embodiments, the private key can be embedded in a component of the mobile device 110 at the time of manufacturing the mobile device. The client subsystem 405 can access the private key from such a component. In other embodiments, the private key can be generated by an offline component (not depicted in FIG. 4) of the mobile device 110. The client subsystem 405 can access the private key from such offline component. The mobile device can retain the private key in an offline component of the mobile device.

In addition, or in some embodiments, the client subsystem 405 can generate a unique symmetric key for the image of the object 410. The unique symmetric key can be retained in one or more memory devices (not depicted in FIG. 4) of the mobile device 110. The unique symmetric key (also referred to as a session key) can be a defined number, for example. In some embodiments, the client subsystem 405 can include a random number generator or a pseudorandom number generator. The mobile device 110 can execute the client subsystem 405 to generate the unique symmetric key. In other embodiments, the mobile device 110 can generate the defined number using at least a measurement of a physical quantity that fluctuates over time. Other sensed values that fluctuate over time also can be used. In yet other embodiments, the mobile device 110 can generate the unique symmetric key using at least a defined input signal that changes over time.

The client subsystem 405 also can generate a unique identifier for the image of the object 410 using at least the unique symmetric key. The client subsystem 405 can watermark the image using the unique identifier. The unique identifier can include, in some embodiments, the unique symmetric key, a concatenation of the unique symmetric key and other information, and/or a code or information (such as metadata) encrypted by the symmetric key.

The client subsystem 405 can watermark the image of the object 410 using at least the unique identifier. To that end, the client subsystem 405 can embed the unique identifier in the digital imaging data representative of the image of the object 410. In some embodiments, instead of embedding the unique identifier throughout the image, the unique identifier may be used as a key for finding a hidden watermark through the image.

In other embodiments, the client subsystem 405 can utilize the unique symmetric key as part of a more involved process that embeds the unique identifier in the digital imaging data representative of the image. For example, instead of embedding the unique identifier throughout the image, the unique identifier may be used as a key for finding a hidden watermark through the captured image.

In some embodiments, in addition to or instead of the generation of the unique identifier, the client subsystem 405 can generate a quick reference number (QRN). The QRN can be assigned to the digital imaging data representative of the image of the object 410 for easy tracking of a particular image within the mobile device 110 and/or after the image is supplied to a network device remotely located relative to the mobile device 110. The QRN can be hidden and/or can be applied to watermark an acquired image (or associated imaging data) so that the QRN can be used by the verification subsystem 240 as an additional validation code. As an alternative, the QRN can be non-obfuscated and placed on a graphical mark or another type of mark to identify an acquired image to any third party as being protected and available for authentication based at least on the QRN.

Regardless the manner of watermarking an acquired image (or the imaging data representative thereof) the watermarked image can be retained on the mobile device 110 for subsequent retrieval. As an alternative, the watermarked image can be immediately processed for uploading to a network device remotely located relative to the mobile device 110.

The client subsystem 405 can digitally sign the watermarked image of the object 410. To that end, in some embodiments, the client subsystem 405 can generate a digital signature by encrypting the watermarked image or a portion thereof using the private key accessed by the client subsystem 405. Thus, the client subsystem 405 generates secure digital imaging data representative of the image of the object 410. Only a subsystem that has access to the public key that is the counterpart of the private key can access the secure digital imaging data.

The mobile device 110 can send the secure digital imaging data representative to a network device remotely located from the mobile device 110. In some embodiments, as part of the execution of the application, the display device 114 can present a selectable visual element that, in response to selection, cause the mobile device 110 to send the secure digital imaging data. The mobile device 110 can utilize or otherwise rely upon a secured communications channel to send the secure digital imaging data. Image acquisition by the mobile device 110 can be terminated in response to (e.g., upon or after) sending the secure imaging data to the server device.

The mobile device 110 can send the secure digital imaging data to one or more of service platform devices 430. As is illustrated in FIG. 4, the service platform devices 430 include multiple server devices 440 and one or more storage devices 450 (generically referred to as repository 450). The server devices 440, individually or in combination, can provide a service to the mobile device 110 based at least on the secure digital imaging data. The service can include the delivery of digital content that is customized based at least on the object 410. The repository 450 can retain multiple media assets 452 (represented as media 452), each of which assets embody or constitute such digital content.

More concretely, as an example, the mobile device 110 can send the secure digital imaging data to a media server device 440a of the server devices 440. To that end, the mobile device 110 can establish a secure communication channel with the media service device 440, via wireless links 315, at least one of the network(s) 310, and the communication architecture 335. The media server device 440a includes various subsystems that can process the secure digital imaging data using a service subsystem 442. As is illustrated in FIG. 4, the media server device 440a can include a verification subsystem 446 that can validate the secure digital imaging data.

In some embodiments, prior to supplying imaging data representative of an image of the object 410, a user account that corresponds to the mobile device 110 can be (or, in some embodiments, must be) registered with a server device of the service platform devices 405. At the time of registration, or before any image acquisition in accordance with this disclosure, the application module 112 can supply a public/private key unique to the user account. Thus, the application module 112 can generate both a private key and a counterpart public key. The mobile device 110 can supply the public key to the media server 440a or another type of device of service platform device 430 that includes a verification subsystem 446. Such registration can permit or otherwise facilitate the verification subsystem 446 to recognize the identity of an end-user linked to the user account and, thus, linked to the mobile device 110. Accordingly, the verification subsystem 446 can associate correct keys with imaging data received from the mobile device 110. The imaging data, as mentioned, is acquired by the mobile device 110 and represents an image of the object 410.

The user account can be identified by any combination of unique identification number of the mobile device 110, a username, password, and/or other consumer identifying data. In some instances, the consumer identifying data can include biometric identification data, such as a fingerprint or a voice print.

The verification subsystem 446 can be configured to verify that digital imaging data received is from an authorized consumer. The verification subsystem 446 can be configured to verify the authenticity of received digital imaging data are authentic. The verification subsystem 446 can be configured to receive information associated with secure digital imaging data received from the mobile device 110. For example, the verification subsystem 446 can receive information such as an identifier associated with the mobile device 110 (e.g., IMSI, IMEI, IP address, phone number, username, and the like), temporal information associated with the content (e.g., a timestamp, a time offset, a time window, a start time, an end time, etc.), location information (e.g., address, coordinates (e.g., Cartesian coordinates, etc.) associated with a frame of the content, any other information (e.g., metadata, content parameters, content settings, etc.), combinations thereof, and the like. In some instances, the verification subsystem 446 can use such information to enforce one or more restrictions specified through a service subsystem 442.

Consumer information and the mobile device can be authenticated or otherwise verified in a variety of different manners and at a variety of different times such as, for example, during account creation, during location declaration, during taking of a photograph of a good, before, during, or after consumer activity, during purchases, during value redemption, etc. The following example embodiments of authentication are for illustrative and example purposes and are not intended to be limiting. Other authentication embodiments are possible and are intended to be within the spirit and scope of the disclosed example embodiments.

In some embodiments, verification may be transparent to an end user of the mobile device 110, e.g., verification occurs without active involvement of the end user. In other words, information transfer and verification occurs in the background. For example, upon establishing communication between the mobile device 110 and the media server device 440a, the verification subsystem 446 can communicate with the mobile device 110 to verify that the device is authentic. Various types of background verifying communication may occur between the media server device 440a and the mobile device 110. These may include communications relying on an active connection to a mobile telecommunication carrier's network to ensure that the mobile device 110 is active, unique, and corresponds with the identifying information provided by the consumer. For example, a push notification or short message service (SMS) may be sent to the mobile device 110 using its device token, IMEI, IMSI, UDID, telephone number, telephony ID, MAC address, etc. This can permit verification via a unique identifier on the network. It also eliminates multiple user accounts on a verified mobile device 110 and permits permanent banning of fraudulent accounts. This verification can permit banning of a particular mobile device 110.

In other embodiments, upon establishing communication between the mobile device 110 and the media server 440a, the verification subsystem 446 can send a communication to the mobile device 110 that is presented on the mobile device 110 and requires a response from the mobile device. The response can include input information from an end-user of the mobile device 110. Such a communication can include, for example, an email, an SMS communication, such as a text messages, or another type of communication. In such example embodiments, a challenge activity may be presented at the mobile device 110 and input information from the end-user must include a defined response in order for the mobile device 110 to be authenticated. For example, the end-user may be required to answer a question, input a passcode, take a picture of themselves, take a picture of a particular item, scan a barcode that may be recorded for future verification via automated or manual methods, etc. In instances in which the input information includes a proper response, the mobile device 110 is authenticated and may be used in accordance with the disclosed example embodiments. In instances in which the input information includes an improper response or lacks a response, the mobile device 110 is not authenticated and digital imaging data (secure or otherwise) from the mobile device 110 can be rejected until such time that the mobile device 110 is authenticated.

In yet other embodiments, upon establishing communication between the mobile device 110 and the media server device 440a, the verification subsystem 446 can establish a telephone call session with the mobile device 110. The telephone call session can be automated or it can be initiated by a human agent. An end-user of the mobile device 110 is required to respond to the telephone call in a particular manner in order for the mobile device 110 to be authenticated. For example, the end-user can be required to answer a question, provide additional information, enter a code, etc. In instances in which the input information includes a proper response, the mobile device 110 is authenticated and may be used in accordance with the disclosed example embodiments. In instances in which the input information includes an improper response or lacks a response, the mobile device 110 is not authenticated and digital imaging data (secure or otherwise) from the mobile device 110 can be rejected until such time that the mobile device 110 is authenticated.

In a further example embodiment, an end-user of the mobile device 110 may be required to use an authenticator. The authenticator can generate a modulating unpredictable, non-repeated communication or code that the consumer is required to enter before the mobile device 110 can be authenticated. The verification subsystem 446 can utilize a duplicate of the authenticator that generates the same communication or code as the authenticator installed on the mobile device 110 and is used to confirm a matching code, resulting in a verified mobile device 110.

Upon or after the mobile device 110 and/or an end-user of the mobile device 110 are verified by the verification subsystem 446, the secure digital imaging data submitted by the mobile device 110 can be authenticated and validated. The verification subsystem 446 can be configured to authenticate and validate still images and motion pictures acquired by the mobile device 110. The verification subsystem 446 not only can permit the detection of image tampering, but also can permit the verification of the time the image was acquired, a location where the image was acquired, and other information that may be used to determine the authenticity and validity of the secure digital imaging data received from the mobile device 110.

In some embodiments, the verification subsystem 446 can receive a digitally signed image (or signed digital imaging data representative of the image). The verification subsystem 446 can authenticate the received digitally signed image in two stages: In a first stage, the verification subsystem 446 can retrieve an identifier of the mobile device 110 to retrieve the public key. The verification subsystem 446 can then decrypt a digital signature using at least a public key corresponding to a counterpart private key associated with the mobile device 110. In a second stage, the verification subsystem 446 can then compare the information extracted from a decrypted digital signature to corresponding information transmitted by the mobile device 110. The digitally signed image is authenticated in response to determining that a private key utilized to encrypt the digitally signed image is the counterpart of the public utilized to decrypt the digitally signed image.

In response to authenticating secure digital imaging data received from the mobile device 110, the verification subsystem 446 can provide the object recognition subsystem 210 with authenticated imaging data representative of the image of the object 410, acquired by the mobile device 110. The object recognition system 210 can analyze or otherwise process the authenticated imaging data in accordance with aspects of this disclosure.

The service subsystem 442 can apply selection rules to identify digital content to be provided to the mobile device 110 in response to an image of the object 410. For example, a first selection rule can dictate that digital content is selected based at least on a group of defined markings detected on the image of the object 410. In one embodiment, an application module 112 can include an application that can provide augmented reality for children books. The application, in response to execution, can cause the mobile device 110 to acquire an image of a page of the book. The client subsystem 405 can generate imaging data and can send the imaging data to the media server 440a, in accordance with aspects of this disclosure.

The media server device 440a, for example, can receive the imaging data. The verification subsystem 446 can determine that imaging data is legitimate in accordance with aspects described herein. The object recognition subsystem 210 can detect keywords (e.g., “bee” and “woodpecker”) and keyphrases (e.g., “little bee” and “playful bird”). Thus, application of the first can result in digital content that includes an animation of the woodpecker playfully following a bee. The service subsystem 442 can send the animation to the application module 112. In response, the application in the application module 112 can cause the display device 114 to overlay the animation on the page imaged by the mobile device 110.

As another example, a second selection rule can dictate that digital content is selected based at least on a form of the object 410 as is identified by the object recognition system 210. In an example in which the object 410 is embodied in a firearm, the object recognition subsystem 210 can detect the form of the firearm. Thus, the second selection rule applied to the imaging data representative of an image of the firearm can result in digital content that includes a video segment on gun safety. The media server device 440a, via the service subsystem 442, for example, can send such digital content to the application module 112. In response, the application retained in the application module 112 can cause the display device 114 to present the visual elements representative of the list.

As yet another example, a third selection rule can dictate that digital content is selected based at least on a marking detected on the image of the object 410 and an identified form of the object 410. For instance, in connection with a packaged foodstuff, the object recognition subsystem 210 can detect a label of the packaged foodstuff (e.g., “Condensed Milk”) and a form of the packaged foodstuff (e.g., can). Thus, the third selection rule applied to the imaging data representative of an image of the packaged foodstuff can result in digital content that includes a video segment of a dessert incorporating condensed milk. The media server device 440a, via the service subsystem 442, for example, can send such digital content to the application module 112. In response, the application retained in the application module 112 can cause the display device 114 to present the video segment.

The service subsystem 442 can apply other selection rules that can permit identifying digital content based on a combination of an image of the object 410 and a configuration of a user account linked to the mobile device and/or the service provided by the application.

In some embodiments, the mobile device 110 also can acquire metadata in response to execution of the application that instructs the acquisition of an image of the object 410. The application can be designed to cause the mobile device 110 to acquire specific types of metadata. In other embodiments, the application can cause the mobile device to identify one or more available types of metadata. The application can then cause the application to acquire a selection of the available type(s) of metadata.

At least some of the metadata that is acquired can supplement digital imaging data and can be utilized for image validation. Accordingly, the term “metadata” as is used herein is intended to refer to all possible types of data that may be acquired in response to image acquisition and that can be potentially relevant to the authenticity or validity of an acquired image.

The richer the metadata (e.g., greater variety, greater amount, and/or greater precision), the greater the confidence can be in subsequent image validation. Thus, metadata can include, for example, one or any combination of position; time; camera module orientation; mobile device velocity; mobile device acceleration; shake/rattle/roll (SRR) of the mobile device; audio; identified network tower nearby (macro-cellular or small-cell network); system state and processes record; EXIF-like data; and the like. The foregoing types of metadata is simply illustrative rather than exhaustive.

Upon acquiring metadata or after the metadata is acquired, the client subsystem 405 included in the application module 112 can incorporate at least some of the acquired metadata into the digital imaging data representative of the image of the object 410. Metadata can be incorporated into respective fields in a group of frames of the image of the object 410. Incorporating metadata into such digital imaging data results in tagged digital imaging data representative of the image of the object 410.

The mobile device 110, via the client subsystem 405, for example, can secure the tagged digital imaging data in accordance with aspects described herein. Securing the tagged digital imaging data can result in secure tagged digital imaging data. In some embodiments, the secure tagged digital imaging data can in include digitally signed imaging data and digitally signed metadata. The mobile device 410 can send the secure tagged digital imaging data to one or more of the server devices 440. For example, the mobile device 410 can send the secure tagged digital imaging data to the media server device 440.

The verification subsystem 446 can process the secure tagged digital imaging data to determine if such data is authentic, in accordance with aspects described herein. Accordingly, the verification subsystem 446 can be configured to receive and use metadata (and other information) associated with the image to authenticate and verify images and videos, and to protect the metadata by public/private key encryption. The metadata may include not only time and date, but also other data such as camera settings (aperture, shutter speed, focal length, and so forth), camera orientation and movement data, and context information such as sounds or words captured contemporaneously with the image, the direction in which the image is taken, and signals from nearby cell towers or WiFi hotspots.

More specifically, position data can include GPS position information indicative or representative of a location of the mobile device 110. The GPS position information can be derived from several sources, individually or in combination. For example, the GPS position information can be derived from a navigation subsystem included in the mobile device 110. The navigation system can include a GPS antenna and chipset. In another example, the GPS position information can be derived from assisted GPS data (A-GPS data) from cellular network servers that provide current satellite ephemeris and timing information directly to the mobile device 110 via a cellular network, a WiFi network, or another network of the network(s) 310. In yet another example, the GPS position information can be derived from inertial sensors (e.g., an accelerometer) included in the mobile device 110.

As is illustrated in FIG. 4, the mobile device 110 can include inertial sensors 420 that can provide (e.g., generate and/or make available) motion data indicative or otherwise representative of instantaneous motion of the mobile device 110. At least some of the motion data can permit or otherwise facilitate the computation of a change in the position of the mobile device 110 as a function time. In the absence of GPS information, the inertial sensors can permit or otherwise facilitate re-computing position from a last known position until GPS information is available again.

The location where the image is captured can be a critical part of the authenticability of the image. Accordingly, providing a “well-grounded” estimate of position is important. In other words, an estimate of location should be the most accurate measure of position over the largest portion of the time interval of an imaging action, as is possible for the mobile device 110 to obtain. The verification subsystem 240 can determine if a location restriction has been applied via, for example, a subsystem included in a server device of the service platform devices 405. In an instance in which such a restriction is applied, the verification subsystem 240 can determine if an image was acquired at an authorized location.

Timing information, such as date and time-of-day data, can be accessed from a macro-cellular network; GPS satellite data; NIST's FM signal; or any of several Internet sites. In a situation in which no connectivity is available to access any of such services, a clock system that is integrated into the mobile device 110 can be leveraged or otherwise relied upon to accurately compute a current time since a last known time.

Live gyroscope data and live accelerometer data can be used, individually or in combination, to compute an orientation of the mobile device 110, e.g., where a lens of the camera module 116 is pointing, as a function of time. Such an orientation can be stored as camera orientation data in one or more memory devices of the mobile device 110. Computed orientation can be stored as a table with the elevation and azimuth of the vector normal to a face member of the mobile device 110 (or the vector normal to the back if with respect to a back facing lens of the mobile device 110).

By determining the position of the center of gravity (CG) of the mobile device 110, live gyroscope data and/or live accelerometer data also can be used to compute a velocity vector of mobile device 110. The velocity vector represents the essentially instantaneous direction of translation of CG of the mobile device as a function of time. For a mobile device 110, movement is probably best understood in terms of speed, change in elevation if any, and change in azimuth (compass heading) if any. Speed can be used to determine whether the consumer using the mobile device 110 was stationary, moving on foot, moving at car speed, or flying during the time period of the imaging event.

The shake/rattle/roll (SRR) of the mobile device 110 is the set of high frequency movements arising from jostling, handling or even dropping the mobile device 110. Like orientation and velocity vectors, SRR can be calculated from live gyroscope and/or accelerometer data. Six elements make up SRR and can be calculated via three rotational movements roll, pitch, and yaw, and three translational movements X, Y and Z (the X-axis being the East-West axis, the Y-axis being the North-South axis, and the Z-axis being the up-down axis). From SRR data, the verification subsystem 240 can determine such things as whether an end-user of the mobile device 110 is running, walking, going up or down stairs, jumping, and the like, during the acquisition of an image.

Network tower and nearby WiFi identification data can be stored that represents the identification of the network towers and the WiFi transmitters nearby the mobile device 110 that are identifiable by the mobile device 110.

Exhangeable Image File Format (Exif)-like data can include camera identification information, imaging settings, and image processing information that characterizes the image that is acquired. Such information can include one or a combination of the image creation date; creation time; dimensions; exposure time; image quality or resolution; aperture; color mode; flash used; focal length; ISO equivalent; image format (e.g., jpeg) process; camera manufacturer; metering mode; camera model; image orientation; and the like.

When and end-user engages the application installed on the mobile device 110 to capture an image, the application may make a record of other applications and/or processes running on the mobile device 110. Other applications and/or processes could interfere with, tamper with or spoof the validity of imaging data being generated during the acquisition of an image of the object 410. In some instances, the client subsystem 405 can block access to other processes and/or applications on the mobile device 110 that can interfere with image acquisition and/or with securing digital imaging data and metadata. Exif data should be considered as part of the metadata that may be captured, and this step may be performed at any time that the data becomes available to the application retained in the application module 112.

The service subsystem 442 also can utilize metadata acquired by the mobile device 110 as a basis for the selection of digital content. The metadata can be utilized in addition to an image of the object 410. As such, to identify digital content, the service subsystem 442 can apply selection rules that contemplate digital imaging data representative of the image of the object 410 and such metadata. For example, a first one of such selection rules can dictate that digital content is selected based at least on a group of defined markings detected on the image of the object 410 and one or more types of metadata. As another example, a second one of such selection rules can dictate that digital content is selected based at least on a form of the object 410 as is identified by the object recognition system 210 and one or more types of metadata.

As yet another example, a third selection rule can dictate that digital content is selected based at least on a marking detected on the image of the object 410, an identified form of the object 410, and one or more types of metadata. For instance, in connection with a packaged foodstuff (a glass container of marinara sauce), metadata can indicate that the image of the object 410 was acquired in the evening. Thus, the third selection rule applied to the imaging data and metadata can result in digital content that includes a recipe for pasta and a list of suitable wines to accompany the recipe.

In some situations, the service subsystem also can utilize or otherwise leverage current configuration of a user account linked to the mobile device 110 and/or linked to the application that consumes the digital content supplied by the media server device 440a.

Continuing with the example in which the “Handy Movie Vault” application is used to receive digital content based at least on an image of the object 410, validation of an image of the object 410 can cause the display device 114 to present an example UI 470, FIG. 4C, that lists several movies available for retrieval and consumption at the mobile device 110. The movies that are listed can be based at least on one or more rules, such as those described hereinbefore. As is illustrated in FIG. 4C, the example UI 470 presents a menu (labeled “FILMS”) of movies that can be received and consumed at the mobile device 110. The menu includes a group of selectable visual elements, each corresponding to one of the movies. As is further illustrated in FIG. 4C, such a group includes a first selectable visual element 472 corresponding to a first movie (e.g., “Phantom of the Opera”); a second selectable visual element 474 corresponding to a second movie (e.g., “A Christmas Wish—The Great Rupert”); a third selectable visual element 476 corresponding to a third movie (e.g., “Peace on Earth”); and a fourth selectable visual element 478 corresponding to a fourth movie (e.g., “The Great Train Robbery”). The example UI 470 also can include a selectable visual element 479 that, in response to being selected, can cause the menu to be hidden or otherwise dismissed. Hiding or dismissing the menu can preclude a selection of a movie in the menu. In some instances, hiding or dismissing the menu can terminate the execution of the “Handy Movie Vault” application in the mobile device 110.

In response to selection of one of the selectable visual elements in the menu, the mobile device 110 can receive the movie from the service platform devices 430 (e.g., the media server device 440a). The mobile device 110 can consume the received movie. As is shown in FIG. 4D, in response to selection of the first selectable visual element 472, an example UI 490 can be presented at the mobile device 110 to consume such a movie. The example UI 490 includes a pane 496 where the movie can be displayed. The mobile device 110 can utilize a media player or another software component having similar functionality to cause the display device 114 to present the UI 490 and other portions of the selected movie. The mobile device 110 can include an audio output unit (e.g., speaker devices; not shown in FIG. 4) that permit reproducing sound included in an audio component of the movie. The media player of the other software component can cause the audio output unit to reproduce the sound corresponding to the audio component.

The media player or the other software component an provide functionalities to control the consumption of selected movie. Such functionalities can include, for example, volume control (element 492); termination control (element 491); trick-play control (element 493a, element 493b, and element 494); and pause control (element 494). Such controls can be implemented in response to selecting and/or manipulating one or more of the visual elements 491 to 495 included in the example UI 490.

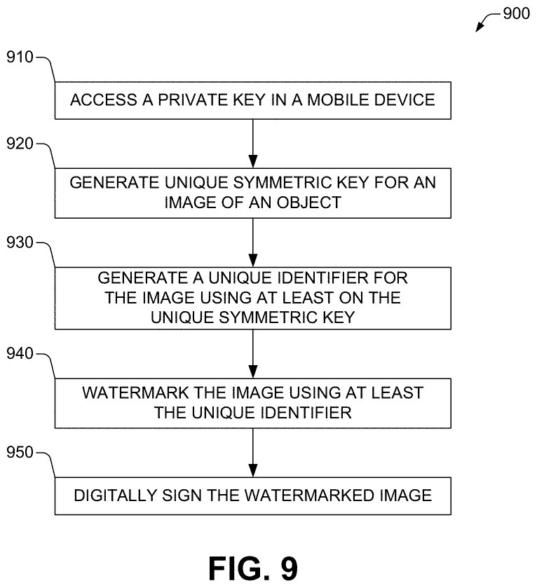

In view of various aspects described herein, examples of the techniques that can be implemented in accordance with this disclosure can be better appreciated with reference to FIGS. 5-7. Specifically, FIG. 5 illustrates a flowchart of an example of a method 500 for providing identification and controlling access using a wearable token, in accordance with one or more embodiments of this disclosure. As mentioned, the wearable token can be embodied in or can include, for example, a removable tattoo, a patch (e.g., a piece of cloth mounted or otherwise sewed to a garment) a sports event bib, an admission badge, or the like. As another example, the wearable token can be embodied in or can include a 3D solid object, such as a wristband, an ornament, a talisman, a garment, or the like. A mobile device having a camera module (e.g., camera module 116) and computing resources can implement at least part of the example method 500. The computing resources include one or more processors (e.g., processor(s) 250) or other types of processing circuitry; one or more memory devices (e.g., memory 290) or other types of storage circuitry; input/output (I/O) interfaces; a combination thereof; or the like. In some embodiments, the mobile device is embodied in or includes the mobile device 110.

At block 510, the mobile device can initiate execution of an application resident in the mobile device. The application can be installed in the mobile device as either hardware or software. As is disclosed herein, in hardware, the application can be embodied in or can constitute a dedicated processing integrated circuit (e.g., an ASIC or a FPGA). At block 520, in response to execution of the application, the mobile device can direct or otherwise cause a display device to present an instruction to acquire an image of the wearable token. The display device can be integrated into the mobile device or otherwise can be functionally coupled to the mobile device.

At block 530, the mobile device can acquire the image of the wearable token by means of the camera module integrated into the mobile device. Acquiring the image includes generating analog signals representative of the image. Imaging sensor devices included in the camera module can generate the analog signals. In addition, or in some embodiments, acquiring the image also can include converting the analog signals to digital data. One or more digitization components in the camera module, for example, can digitize the analog signals. The digital data also represents the image of the object. Further, or in yet other embodiments, acquiring the image can include formatting the digital data according to a format for storing digital content. The formatted digital data can constitute imaging data representative of the object.

At block 540, the mobile device can determine if a group of defined markings are present on the image of the wearable token. As is disclosed herein, at least one marking of the group of defined markings can have respective particular semantics. For example, a first marking of the defined markings can include a legend another type of inscription. As another example, a second marking of the defined markings can include a logo or another type of mark representative of an entity or a live event.

In some embodiments, determining if the group of defined markings are present on the image of the wearable token can include performing one or multiple machine-vision technique that can identify at least one marking of the group of defined markings. In addition, or in other embodiments, determining if the group of defined markings are present on the image of the wearable token can include applying a machine-learning model to the image. The machine-learning model is trained to identify each (or, in some instances, at least one) marking of the group of defined markings.

In some scenarios, the mobile device can determine that the group of defined markings is absent from the image of the wearable token (“No” branch in FIG. 5). In response, flow of the example method 500 can continue to block 550, at which block the mobile device can perform an exception handling process. As mentioned, in some embodiments, performing the exception handling process can include causing the display device to present information indicative of the wearable token being in a fault state. The fault state can include, for example, an access-denied state in connection with access to a facility or another type of premises. Such information can be conveyed with a group of visual elements (text, images, etc.) and/or a group of aural elements (e.g., utterances or other types of sound).

In the alternative, flow of the example method 500 can continue to block 560 in response to the mobile device detecting the group of the defined markings on the image (“Yes” branch in FIG. 5). At block 560, the mobile device can cause the display device to present information based at least on one or more first markings of the group of defined markings. Presenting the information can include, for example, presenting a group of visual elements indicative of an identify linked to the wearable token. The identity can be encoded or otherwise represented by a particular marking of the defined markings. In one example, the particular marking can include a unique string of alphanumeric characters (e.g., fourth indicia 106d, FIG. 1). In addition, or in other embodiments, presenting the information can include presenting a group of visual elements indicative of a location within a venue. The location can correspond to a role (e.g., runner, bouncer, musician, VIP attendee, etc.) linked to the wearable token.

At block 570, the mobile device can cause an apparatus to perform an operation based at least on the first marking(s) and/or one or more second markings of the group of defined markings. The apparatus can have a specific functionality and the operation can correspond to a function included in the specific functionality. Such functionality is particular to the architecture of the apparatus, e.g., a display apparatus, an automated locking apparatus, an automated gate apparatus, and the like. The apparatus can be embodied in or can include the access control apparatus 130. As is disclosed herein, in some embodiments, the mobile device can send an instruction wirelessly to the apparatus to direct the apparatus to perform the operation. The instruction can be formatted or otherwise configured according to a control protocol that permits of otherwise facilitates the automation control of the apparatus. Again, the control protocol can include various types of fieldbus protocols.

FIG. 6 illustrates a flowchart of an example method 600 for providing identification and controlling access using a wearable token, in accordance with one or more embodiments of this disclosure. The wearable token can be embodied in or can include a three-dimensional solid object, such as a wristband, an ornament, a garment, or the like. A mobile device having a camera module (e.g., camera module 116) and computing resources can implement at least part of the example method 200. The computing resources include one or more processors (e.g., processor(s) 250) or other types of processing circuitry; one or more memory devices (e.g., memory 290) or other types of storage circuitry; input/output (I/O) interfaces; a combination thereof; or the like. In some embodiments, the mobile device is embodied in or includes the mobile device 110.

At block 610, the mobile device can initiate execution of an application resident in the mobile device. The application can be installed in the mobile device as either hardware or software. Again, in hardware, the application can be embodied in or can constitute, for example, an ASIC, a FPGA, or another type of dedicated processing integrated circuit. At block 620, in response to execution of the application, the mobile device can cause a display device to present an instruction to acquire an image of a wearable token. As mentioned, in some embodiments, the display device can be integrated into the mobile device.

At block 630, the mobile device can acquire the image of the wearable token by means of a camera module integrated into the mobile device. Acquiring the image includes generating analog signals representative of the image. Imaging sensor devices included in the camera module can generate the analog signals. In addition, or in some embodiments, acquiring the image also can include converting the analog signals to digital data. One or more digitization components in the camera module, for example, can digitize the analog signals. The digital data also represents the image of the object. Further, or in yet other embodiments, acquiring the image can include formatting the digital data according to a format for storing digital content. The formatted digital data can constitute imaging data representative of the object.

At block 640, the mobile device can identify a form of the wearable token. To that end, in some embodiments, the mobile device can detect geometrical features of the wearable token. As mentioned, the geometrical features can include edges (straight, nearly straight, and/or curved), vertices, apparent contours, and the like. The mobile device can identify the form of the wearable token using at least the geometrical features. In some embodiments, the mobile device can infer a form (e.g., a 3D shape) corresponding to the geometrical features (also referred to as image features). To that end, the mobile device can apply a statistical shape model in accordance with aspects of this disclosure. Such a model can be applied by executing the object recognition subsystem 210.

At block 650, the mobile device can determine if the identified form matches a defined form of a reference object. For instance, the mobile device can determine if the identified form satisfies one or more matching criteria relative to the reference object. In response to a negative determination (“No” branch in FIG. 6) the flow of the example method 600 continues to block 660, at which block the mobile device can perform an exception handling process. As mentioned, in some embodiments, performing the exception handling can include causing the display device to present information indicative of the wearable token being in a fault state. The fault state can include, for example, an access-denied state in connection with access to a facility or another type of premises. Such information can be conveyed with a group of visual elements (text, images, etc.) and/or a group of aural elements (e.g., utterances or other types of sound).

In the alternative, flow of the example method 600 continues to block 670 in response to an affirmative determination at block 650 (“Yes” branch in FIG. 6). At block 670, the mobile device can cause the display device to present information based at least on the identified form (e.g., identified shape and/or identified structure).

At block 680, the mobile device can cause an apparatus to perform an operation based at least on the identified form. Again, the apparatus can have a specific functionality and the operation can correspond to a function included in the specific functionality. Such functionality is particular to the architecture of the apparatus, e.g., a display apparatus, an automated locking apparatus, an automated gate apparatus, and the like. The apparatus can be embodied in or can include the access control apparatus 130. As is disclosed herein, in some embodiments, the mobile device can send an instruction wirelessly to the apparatus to direct the apparatus to perform the operation. The instruction can be sent via a radio module (e.g., radio module 118) having one or more antennas and processing circuitry that permits sending wireless signals. As mentioned, such an instruction can be formatted or otherwise configured according to a control protocol that permits of otherwise facilitates the automated operation of the apparatus.

The respective techniques illustrated by the example method 400 shown in FIG. 5 and the example method 400 shown in FIG. 6 can be combined. Such a combination results in another technique that can be applicable to wearable tokens having various kinds of markings in addition to a particular morphology.

More concretely, FIG. 7 presents a flowchart of an example method 700 that exemplifies the technique that results from the aforementioned combination. As mentioned, a mobile device having a camera module and computing resources can implement at least part of the example method 700. Again, the computer resources include one or more processors or other types of processing circuitry; one or more memory devices or other types of storage circuitry; I/O interfaces; a combination thereof; or the like. In some embodiments, the mobile device is embodied in or includes the mobile device 110.

At block 710, the mobile device can initiate execution of an application resident in the mobile device. The application can be installed in the mobile device as either hardware or software. Again, in hardware, the application can be embodied in or can constitute, for example, an ASIC, a FPGA, or another type of dedicated processing integrated circuit. At block 715, in response to execution of the application, the mobile device can direct or otherwise cause a display device to present an instruction to acquire an image of a wearable token. The display device can be integrated into the mobile device or otherwise can be functionally coupled to the mobile device.

At block 720, the mobile device can acquire the image of the wearable token by means of a camera module (e.g., camera module 116) integrated into the mobile device. Acquiring the image includes generating analog signals representative of the image. Imaging sensor devices included in the camera module can generate the analog signals. In addition, or in some embodiments, acquiring the image also can include converting the analog signals to digital data. One or more digitization components in the camera module, for example, can digitize the analog signals. The digital data also represents the image of the object. Further, or in yet other embodiments, acquiring the image can include formatting the digital data according to a format for storing digital content. The formatted digital data can constitute imaging data representative of the object.

At block 725, the mobile device can determine if a group of defined markings are present in the image of the wearable token. As is disclosed herein, at least one marking of the defined markings can have a particular semantics. As is disclosed herein, in some embodiments, determining if the group of defined markings are present on the image of the wearable token can include performing one or multiple machine-vision technique that can identify at least one marking of the group of defined markings. In addition, or in other embodiments, determining if the group of defined markings are present on the image of the wearable token can include applying a machine-learning model to the image. The machine-learning model is trained to identify each (or, in some instances, at least one) marking of the group of defined markings.

In some scenarios, the mobile device can determine that the group of defined markings is absent from the image of the wearable token (“No” branch in FIG. 7). In response, flow of the example method 700 can continue to block 730, at which block the mobile device can perform an exception handling process.

In the alternative, flow of the example method 700 can continue to block 735 in response to the mobile device detecting the group of the defined markings on the image (“Yes” branch in FIG. 7). At block 750, the mobile device can identify a form of the wearable token. To that end, in some embodiments, the mobile device can detect geometrical features of the wearable token. As mentioned, the geometrical features can include edges (straight, nearly straight, and/or curved), vertices, apparent contours, and the like. The mobile device can identify the form of the wearable token using at least the geometrical features. In some embodiments, the mobile device can infer a form (e.g., a 3D shape) corresponding to the geometrical features. To that end, the mobile device can apply a statistical shape model. Such a model can be applied by executing the object recognition subsystem 210.

At block 750, the mobile device can determine if the identified form matches a defined form of a reference object. For instance, the mobile device can determine if the identified form satisfies one or more matching criteria relative to the reference object. In response to a negative determination (“No” branch in FIG. 7) the flow of the example method 700 continues to block 770, at which block the mobile device can perform an exception handling process.

In the alternative, flow of the example method 700 continues to block 750 in response to an affirmative determination (“Yes” branch in FIG. 7). At block 750, the mobile device can cause the display device to present information based at least on one or more first markings of the group of defined markings and/or the identified form (e.g., identified shape and/or identified structure). As mentioned, presenting the information can include, for example, presenting a group of visual elements indicative of an identify linked to the wearable token. The identity can be encoded or otherwise represented by a particular marking of the defined markings. In addition, or in other embodiments, presenting the information can include presenting a group of visual elements indicative of a location within a venue. The location can correspond to a role (e.g., runner, bouncer, musician, VIP attendee, etc.) linked to the wearable token.

At block 755, the mobile device can cause an apparatus to perform an operation based at least on the first marking(s), one or more second markings of the group of defined markings, and/or the identified form. As is disclosed herein, the apparatus can have a specific functionality and the operation can correspond to a function included in the specific functionality. Such functionality is particular to the architecture of the apparatus, e.g., a display apparatus, a locking apparatus, a gate apparatus, and the like. The apparatus can be embodied in or can include the access control apparatus 130. In some embodiments, the mobile device can send an instruction wirelessly to the apparatus to direct the apparatus to perform the operation. The instruction can be formatted or otherwise configured according to a control protocol that permits of otherwise facilitates the automation control of the apparatus. Again, the control protocol can include various types of fieldbus protocols.

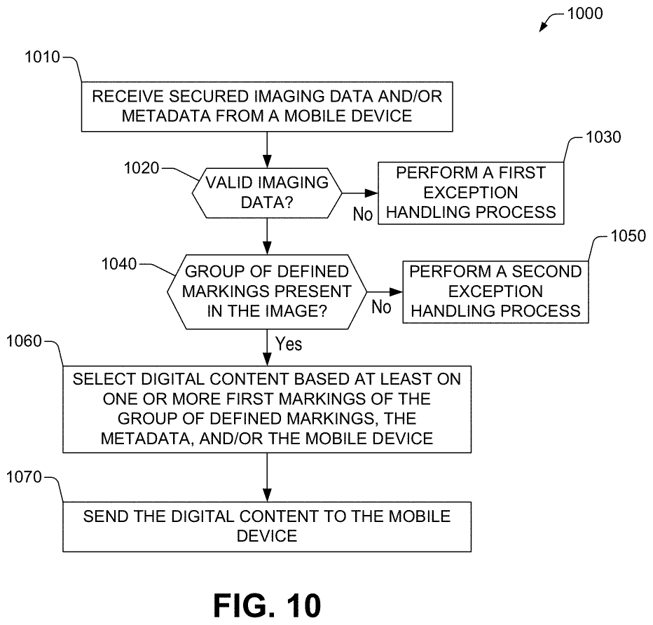

FIG. 8 presents a flowchart of an example of a method 800 for transferring imaging data from a mobile device to a server device, in accordance with one or more embodiments of the disclosure. The imaging data can be representative of an image of an object. The server device is remotely located relative to the mobile device. The server device can be embodied in one of the service platform devices 430. The mobile device can have a camera module and computing resources that can implement at least part of the example method 800. Again, the computer resources include one or more processors or other types of processing circuitry; one or more memory devices or other types of storage circuitry; I/O interfaces; a combination thereof; or the like. In some embodiments, the mobile device is embodied in or includes the mobile device 110.

Prior to transferring imaging data representative of an image of an object, a user account that corresponds to the mobile device can be (or, in some embodiments, must be) registered with another server device functionally coupled to the server device that receives the imaging data. As is disclosed herein, such a registration can permit or otherwise facilitate authenticating an end-user linked to the mobile device prior to the transfer of the imaging data.

At block 810, the mobile device can initiate execution of an application resident in the mobile device. The application can be installed in the mobile device as either software or hardware (e.g., an ASIC, a FPGA, or another type of dedicated integrated circuit). As such, the application can be embodied in, for example, the application 295 or another application retained in the application module 210. At block 820, in response to execution of the application, the mobile device can cause a display device to present an instruction to acquire an image of a wearable token. In some embodiments, the display device can be integrated into the mobile device.

At block 830, the mobile device can acquire the image of the object by means of a camera module integrated into the mobile device. Acquiring the image includes generating analog signals representative of the image. Imaging sensor devices included in the camera module can generate the analog signals. In addition, or in some embodiments, acquiring the image also can include converting the analog signals to digital data. One or more digitization components in the camera module, for example, can digitize the analog signals. The digital data also represents the image of the object. Further, or in yet other embodiments, acquiring the image can include formatting the digital data according to a format for storing digital content. The formatted digital data can constitute imaging data representative of the object.

At block 840, the mobile device can acquire metadata from a network device and/or a sensor device in the mobile device. The metadata can include, for example, one type or a combination of types of metadata disclosed herein. In some embodiments, the mobile device can acquire the metadata in response to initiating the executing an application in the mobile device. Executing the application permits or otherwise facilitates providing a service to mobile device. The service can include, for example, the delivery of digital content customized to an object that is imaged by the mobile device.

In some embodiments, as part of the example method 800, the mobile device can acquire other information besides metadata. The information can be acquired in addition to or instead of the metadata acquired at block 840. As an example, in response to executing the application, the mobile device can generate a record of other applications and/or processes executing on the mobile device 110. Such applications and/or processes can interfere with, tamper with, or spoof the validity of imaging data generated during the acquisition of an image of an object. Thus, in some embodiments, as part of the example method 800, the mobile device can block access to a process and/or an application on the mobile device that can interfere with block 830, for example.

As is any of the other techniques disclosed herein, the example method 800 is not limited to the illustrated order of operations. For example, the mobile device need not acquire the metadata in response to initiating the execution of the application at block 810. In some instances, the mobile device can acquire the metadata before initiating the execution of the application. In other instances, the mobile device can acquire the metadata in response to the execution of the application but before any one of blocks 820 and 830. In yet other instances, the mobile device can acquire the metadata during the performance of one or both of block 820 or block 830.

While not shown in FIG. 8, in some embodiments, the example method 800 can include tagging the imaging data representative of the image with at least some of the acquired metadata. The tagged digital data constitutes imaging data that also represents the image of the object.

At block 850, the mobile device can generate secure imaging data representative of the image. Secure imaging data can be generated in numerous ways. For example, generating the secure imaging data can include encrypting tagged imaging data. In another example, generating the imaging data can include encrypting non-tagged data.

At block 860, the mobile device can send the secure imaging data to a server device. The mobile device can utilize or otherwise rely upon a secured communications channel to send the secure imaging data. Image acquisition by the mobile device 110 can be terminated in response to (e.g., upon or after) sending the secure imaging data to the server device.

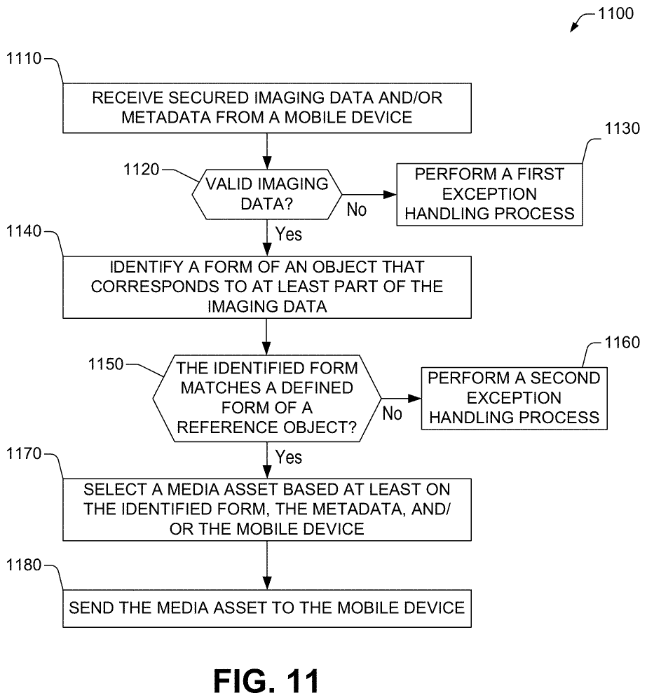

FIG. 9 presents a flowchart of an example of a method 900 for securing imaging data generated by a mobile device, in accordance with one or more embodiments of this disclosure. The mobile device can have a camera module and computing resources can implement at least part of the example method 900. Again, the computer resources include one or more processors or other types of processing circuitry; one or more memory devices or other types of storage circuitry; I/O interfaces; a combination thereof; or the like. In some embodiments, the mobile device is embodied in or includes the mobile device 110.

At block 910, the mobile device can access a private key within the mobile device. The private key that is accessed can be a part of a private/public key pair of a cryptosystem associated with the mobile device. In some embodiments, the private key can be embedded in a component of the mobile device at the time of manufacturing the mobile device. In other embodiments, can be generated by the mobile device after the mobile device is manufactured. The mobile device can retain the private key in an offline component of the mobile device.

At block 920, the mobile device can generate a unique symmetric key for an image of an object. The mobile device can acquire the image. The unique symmetric key (also referred to as a session key) can be a defined number. In some embodiments, the mobile device can generate the defined number by executing a random number generator or a pseudorandom number generator. In other embodiments, the mobile device can generate the defined number using at least a measurement of a physical quantity that fluctuates over time. Other sensed values that fluctuate over time also can be used. In yet other embodiments, the mobile device can generate the unique symmetric key using at least a defined input signal that changes over time.

At block 930, the mobile device can generate a unique identifier for the image using at least on the unique symmetric key. The unique identifier can include, in some embodiments, the unique symmetric key, a concatenation of the unique symmetric key and other information, and/or a code or information (such as metadata) encrypted by the unique symmetric key.

At block 940, the mobile device can watermark the image using at least the unique identifier. While not shown in FIG. 9, in some embodiments, the mobile device can retain the watermarked image in one or more memory devices of the mobile device, for subsequent retrieval. In order to watermark the image, the mobile device can embed the unique identifier in imaging data representative of the image. In some embodiments, instead of embedding the unique identifier throughout the image, the unique identifier may be used as a key for finding a hidden watermark through the image.

At block 950, the mobile device can digitally sign the watermarked image. To that end, in some embodiments, the mobile device can generate a digital signature by encrypting the watermarked image or a portion thereof using the private key accessed at block 910. Thus, the image of the object has been secured in a manner that only a subsystem that has access to the public key that is the counterpart of the private key in the private/public key pair of associated with the mobile device.

In addition to the digitally-signed watermarked image (or imaging data associated with the image), the mobile device can digitally sign metadata and/or the unique symmetric key, to further secure information related to image.

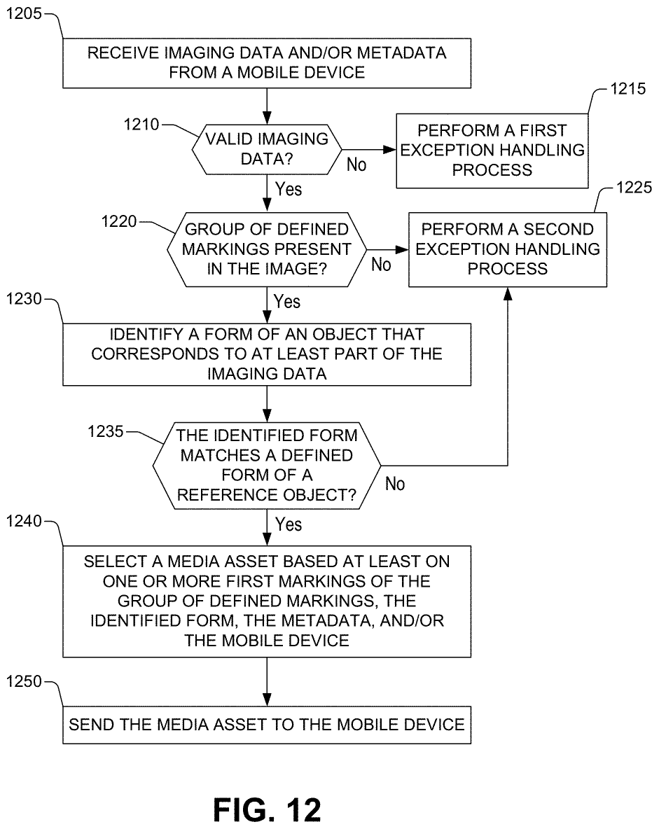

FIG. 10 presents a flowchart of an example of a method 1000 for providing digital content, in accordance with one or more embodiments of this disclosure. A computing system having computing resources can implement at least part of the example method 1000. Again, the computer resources include one or more processors or other types of processing circuitry; one or more memory devices or other types of storage circuitry; I/O interfaces; a combination thereof; or the like. The computing system includes server devices and storage devices. In some embodiments, the computing system can be embodied in or can include the service platform devices 430. The server devices include at least one of the server devices 440.

At block 1010, the computing system can receive secured imaging data and/or metadata from a mobile device. The imaging data can represent an image of an object. As is disclosed herein, the mobile device can generate the imaging data in response to acquiring the image. In some embodiments, the mobile device (e.g., mobile device 110) can secure the imaging data in accordance with aspects of this disclosure. The metadata can be one of the several types of metadata disclosed herein or a combination of those types of metadata.

At block 1020, the computing system can determine if the imaging data is valid. In embodiments in which the imaging data is encrypted using a private key, the computing system can perform a defined private/public key encryption challenge. Regardless the type of validation protocol, in response to a negative determination (“No” branch in FIG. 8), the flow of the example method 1000 continues to block 1030, at which block the computing system can perform a first exception handling process. In the alternative, in response to a positive determination—e.g., the imaging data is authenticated—the flow of the example method 1000 continues to block 1040 for further analysis.

Specifically, at block 1040, the computing system can determine if a group of defined markings is present in the image. Such a determine can be performed in similar or same manner as is performed in other techniques of this disclosure. As an example, the computing system can include a group of server devices that, individually or in combination, can execute the object recognition subsystem 210 to determine the presence or absence of the group of defined markings in the image. Again, the group of defined markings can include specific text; one or more specific graphical marks; or a combination of thereof. The specific text can include separate, individual characters, without express meaning individually. In addition, or as an alternative, the specific text can include words, phrases, legends, passages, or a combination thereof. Such characters can include letters, numbers, special characters, or a combination thereof. A special character can have, in some instances, semantic meaning.

Flow of the example method 1000 continues to block 1050 in response to a negative determination (“No” branch) at block 1040. At block 1050, the computing system can perform a second exception handling process. Consistent with other exception handling processes of this disclosure, in some embodiments, the computing system can send instructions to the mobile device to provide notifications related to the absence of the defined group of markings in the image. In the alternative, flow of the example method 1000 continues to block 1060 in response to a positive determination at block 1040—e.g., the group of defined markings is detected in the image. At block 1060, the computing system can select digital content based at least on one or more of the first markings of the group of defined markings, the metadata, and/or the mobile device. The digital content can include a media asset, such as an audio segment, a still image, or a motion picture. Still images can include text, graphical marks, or a combination thereof. Such text can include individual characters, words, phrases, legends, passages, or a combination thereof. Such characters can include letters, numbers, special characters. A special character can have, in some instances, semantic meaning, such as it may be the case for a character in foreign language. Motion pictures can include, for example, animations or video segments. Some types of motion pictures can include audio (e.g., noise, utterances, and/or speech) and other types of motion pictures can be silent.

At block 1070, the computing system can send the digital content to the mobile device (e.g., mobile device 110). The digital content can be sent in various modalities. In one modality, the digital content is embodied in a discrete media asset that is sent in its entirety to the mobile device. In another modality, the digital content can be streamed to the mobile device. In some embodiments, a subgroup of the server devices 440 can send the digital content. The subgroup of the server devices 440 together with the media storage 452 can embody or otherwise can constitute a content delivery network (CDN) that can send the digital content to the mobile device.

FIG. 11 presents a flowchart of an example of another method 1100 for providing digital content, in accordance with one or more embodiments of this disclosure. As mentioned, a computing system having computing resources can implement at least part of the example method 1100. As is disclosed herein, the computer resources include one or more processors or other types of processing circuitry; one or more memory devices or other types of storage circuitry; I/O interfaces, network adapters and other communication architectures; a combination thereof or the like. The computing system includes server devices and storage devices. In some embodiments, the computing system can be embodied in or can include the service platform devices 430. The server devices include at least one of the server devices 440.

At block 1110, the computing system can receive secured imaging data and/or metadata from a mobile device. The imaging data can represent an image of an object (e.g., object 410). As is disclosed herein, the mobile device can generate the imaging data in response to acquiring the image. In some embodiments, the mobile device (e.g., mobile device 110) can secure the imaging data in accordance with aspects of this disclosure. The metadata can be one of the several types of metadata disclosed herein or a combination of those types of metadata.

At block 1120, the computing system can determine if the imaging data is valid. As mentioned, in embodiments in which the imaging data is encrypted using a private key, the computing system can perform a defined private/public key encryption challenge. Regardless the type of validation protocol, in response to a negative determination (“No” branch), the flow of the example method 1100 continues to block 1130, at which block the computing system can perform a first exception handling process. In the alternative, in response to a positive determination—e.g., the imaging data is authenticated—the flow of the example method 1100 continues to block 1140 for further analysis.

At block 1140, the computing system can identify a form of an object that corresponds to at least part of the imaging data. Such a form can be identified in accordance with aspects described herein. More concretely, in some embodiments, to identify the form of the object, the computing system can detect geometrical features of such an object. Again, the geometrical features can include edges (straight, nearly straight, and/or curved), vertices, apparent contours, and the like. The computing system can identify the form of the object using at least the geometrical features. In one of such embodiments, the computing system can infer a form (e.g., a 3D shape) corresponding to the geometrical features. As mentioned, the geometrical features also can be referred to as image features. To perform such an inference, the computing system can apply a statistical shape model in accordance with aspects of this disclosure. Such a model can be applied by executing the object recognition subsystem 210.

At block 1150, the computing system can determine if the identified form matches a defined form of a reference object. For instance, the computing system can determine if the identified form satisfies one or more matching criteria relative to the reference object. In response to a negative determination (“No” branch) the flow of the example method 1100 continues to block 1160, at which block the computing system can perform a second exception handling process. As mentioned, in some embodiments, performing the second exception handling process can include sensing instructions to the mobile device to present information indicative of the object not being recognizable. The instructions also can direct, the mobile device to present remedial information, for example. Utilizing the remedial information (e.g., a suggestion to replace the object, adjust lighting, etc.) can permit recognizing the object in a subsequent submission of second imaging data representative of another image of the object. The fault state can include, for example, an access-denied state in connection with access to a facility or another type of premises. Such information can be conveyed with a group of visual elements (text, images, etc.) and/or a group of aural elements (e.g., utterances or other types of sound).

Flow of the example method 1100 continues to block 1170 in response to a positive determination at block 1150—e.g., the identified form is recognized. At block 1170, the computing system can select digital content based at least on the identified form, the metadata, and/or the mobile device. As is disclosed herein, the digital content can include a media asset, such as an audio segment, a still image, or a motion picture. Still images can include text, graphical marks, or a combination thereof, similar to other embodiments of this disclosure. In addition, motion pictures can include, for example, animations or video segments. Some types of motion pictures can include audio (e.g., noise, utterances, and/or speech) and other types of motion pictures can be silent.

At block 1180, the computing system can send the digital content to the mobile device (e.g., mobile device 110). The digital content can be sent in various modalities. In one modality, the digital content is embodied in a discrete media asset that is sent in its entirety to the mobile device. In another modality, the digital content can be streamed to the mobile device. In some embodiments, a subgroup of the server devices 440 can send the digital content. The subgroup of the server devices 440 together with the media storage 452 can embody or otherwise can constitute a CDN that can send the digital content to the mobile device.

FIG. 12 presents a flowchart of an example of yet another method 1200 for providing digital content, in accordance with one or more embodiments of this disclosure. As mentioned, a computing system having computing resources can implement at least part of the example method 1200. As is disclosed herein, the computer resources include one or more processors or other types of processing circuitry; one or more memory devices or other types of storage circuitry; I/O interfaces, network adapters and other communication architectures; a combination thereof; or the like. The computing system includes server devices and storage devices. In some embodiments, the computing system can be embodied in or can include the service platform devices 430. The server devices include at least one of the server devices 440.

At block 1205, the computing system can receive secured imaging data and/or metadata from a mobile device. The imaging data can represent an image of an object (e.g., object 410). As is disclosed herein, the mobile device can generate the imaging data in response to acquiring the image. In some embodiments, the mobile device (e.g., mobile device 110) can secure the imaging data in accordance with aspects of this disclosure. The metadata can be one of the several types of metadata disclosed herein or a combination of those types of metadata.

At block 1210, the computing system can determine if the imaging data is valid. As mentioned, in embodiments in which the imaging data is encrypted using a private key, the computing system can perform a defined private/public key encryption challenge. Regardless the type of validation protocol, in response to a negative determination (“No” branch), the flow of the example method 1200 continues to block 1215, at which block the computing system can perform a first exception handling process. In the alternative, in response to a positive determination—e.g., the imaging data is authenticated—the flow of the example method 1200 continues to block 1220 for further analysis.

Specifically, at block 1220, the computing system can determine if a group of defined markings is present in the image. Such a determination can be performed in similar or same manner as is performed in other techniques of this disclosure. As an example, the computing system can include a group of server devices that, individually or in combination, can execute the object recognition subsystem 210 to determine the presence or absence of the group of defined markings in the image. Again, the group of defined markings can include specific text; one or more specific graphical marks; or a combination of thereof. The specific text can include separate, individual characters, without express meaning individually. In addition, or as an alternative, the specific text can include words, phrases, legends, passages, or a combination thereof. Such characters can include letters, numbers, special characters, or a combination thereof. A special character can have, in some instances, semantic meaning.

Flow of the example method 1200 continues to block 1225 in response to a negative determination (“No” branch) at block 1220. At block 1225, the computing system can perform a second exception handling process. Consistent with other exception handling processes of this disclosure, in some embodiments, the computing system can send instructions to the mobile device to provide notifications related to the absence of the defined group of markings in the image. The instructions also can direct the mobile device to present remedial information, for example. Utilizing the remedial information (e.g., a suggestion to replace the object, adjust lighting, etc.) can permit a positive determination at block 1220. The fault state can include, for example, an access-denied state in connection with access to a facility or another type of premises. Such information can be conveyed with a group of visual elements (text, images, etc.) and/or a group of aural elements (e.g., utterances or other types of sound).

In the alternative, flow of the example method 1200 continues to block 1230 in response to a positive determination at block 1220—e.g., the group of defined markings is detected in the image. At block 1230, the computing system can identify a form of an object that corresponds to at least part of the imaging data. Such a form can be identified in accordance with aspects described herein. More concretely, in some embodiments, to identify the form of the object, the computing system can detect geometrical features of such an object. Again, the geometrical features can include edges (straight, nearly straight, and/or curved), vertices, apparent contours, and the like. The computing system can identify the form of the object using at least the geometrical features. In one of such embodiments, the computing system can infer a form (e.g., a 3D shape) corresponding to the geometrical features. As mentioned, the geometrical features also can be referred to as image features. To perform such an inference, the computing system can apply a statistical shape model in accordance with aspects of this disclosure. Such a model can be applied by executing the object recognition subsystem 210.

At block 1235, the computing system can determine if the identified form matches a defined form of a reference object. For instance, the computing system can determine if the identified form satisfies one or more matching criteria relative to the reference object. In response to a negative determination (“No” branch) the flow of the example method 1200 continues to block 1225, at which block the computing system can perform the second exception handling process.

Flow of the example method 1200 continues to block 1240 in response to a positive determination at block 1235—e.g., the identified form is recognized. At block 1240, the computing system can select digital content based at least on one or more of the first markings of the group of defined markings, the identified form, the metadata, and/or the mobile device. As is disclosed herein, the digital content can include a media asset, such as an audio segment, a still image, or a motion picture. Still images can include text, graphical marks, or a combination thereof, similar to other embodiments of this disclosure. In addition, motion pictures can include, for example, animations or video segments. Some types of motion pictures can include audio (e.g., noise, utterances, and/or speech) and other types of motion pictures can be silent.

At block 1250, the computing system can send the digital content to the mobile device (e.g., mobile device 110). The digital content can be sent in various modalities. In one modality, the digital content is embodied in a discrete media asset that is sent in its entirety to the mobile device. In another modality, the digital content can be streamed to the mobile device. In some embodiments, a subgroup of the server devices 440 can send the digital content. The subgroup of the server devices 440 together with the media storage 452 can embody or otherwise can constitute a CDN that can send the digital content to the mobile device.

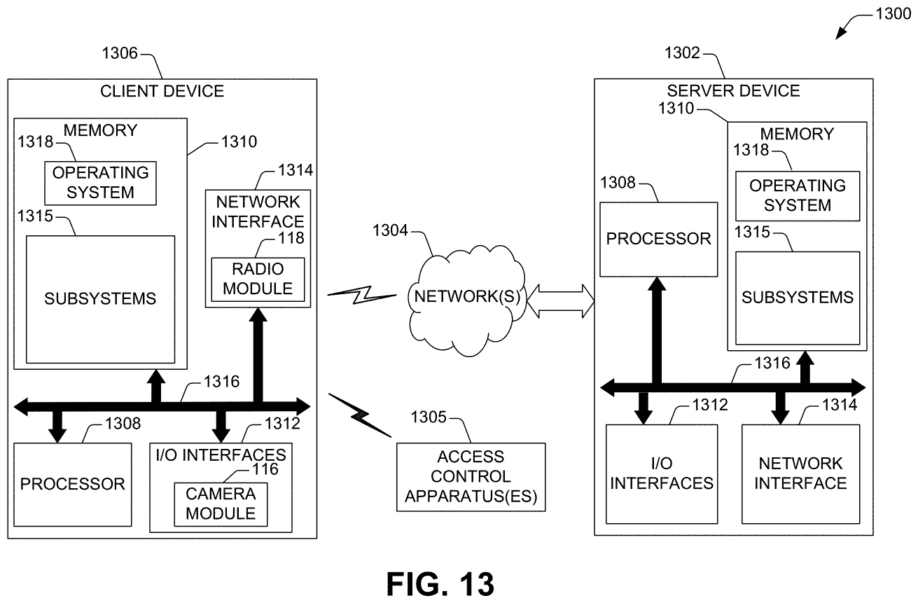

FIG. 13 illustrates an example of a computing environment 1300 including examples of a server device 1302 and a client device 1306 (e.g., mobile device 110) mutually functionally coupled by means of one or more networks 1304, such as the Internet or any wireline or wireless connection. The server device 1302 and the client device 1306 can be a digital computer that, in terms of hardware architecture, can include one or more processor 1308 (generically referred to as processor 1308), one or more memory devices 1310 (generically referred to as memory 1310), input/output (I/O) interfaces 1312, and network interfaces 1314. These components (1308, 1310, 1312, and 1314) are communicatively coupled via a communication interface 1316. The communication interface 1316 can be embodied in or can include, for example, one or more bus architectures or other wireline or wireless connections. One or more of the bus architectures can include an industrial bus architecture, such as an Ethernet-based industrial bus, a controller area network (CAN) bus, a Modbus, other types of fieldbus architectures, or the like. The communication interface 1316 can have additional elements, which are omitted for simplicity, such as controller device(s), buffer device(s) (e.g., caches), drivers, repeaters, transmitter device(s), and receiver device(s), to enable communications. Further, the communication interface 1316 may include address, control, and/or data connections to enable appropriate communications among the aforementioned components.

The processor 1308 can be a hardware device that includes processing circuitry that can execute software, particularly that stored in the memory 1310. In addition, or as an alternative, the processing circuitry can execute defined operations besides those operations defined by software. The processor 1308 can be any custom made or commercially available processor, a central processing unit (CPU), a graphical processing unit (GPU), an auxiliary processor among several processors associated with the server device 1302 and the client device 1306, a semiconductor-based microprocessor (in the form of a microchip or chipset), or generally any device for executing software instructions or performing defined operations. When the server device 1302 or the client device 1306 is in operation, the processor 1308 can be configured to execute software stored within the memory 1310, for example, in order to communicate data to and from the memory system 1310, and to generally control operations of the server device 1302 and the client device 1306 according to the software.

The I/O interfaces 1312 can be used to receive user input from and/or for providing system output to one or more devices or components. User input can be provided via, for example, a keyboard, a touchscreen display device, a microphone, and/or a mouse. System output can be provided, for example, via the touchscreen display device or another type of display device. I/O interfaces 1312 can include, for example, a serial port, a parallel port, a Small Computer System Interface (SCSI), an infrared (IR) interface, an radiofrequency (RF) interface, and/or a universal serial bus (USB) interface.

The network interface 1314 can be used to transmit and receive data, metadata, and/or signaling from an external server device 1302, an external client device 1306, and other types of external apparatuses on one or more of the network(s) 1304. The network interface 1314 also permits transmitting data, metadata, an/or signaling to access control apparatus(es) 1305 and receiving other data, metadata, and/or signaling from the access control apparatus(es). The network interface 1314 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi), or any other suitable network interface device. Accordingly, as is illustrated in FIG. 13, the network interface 1314 in the client device 1306 can include the radio module 118. The network interface 1314 may include address, control, and/or data connections to enable appropriate communications on the network(s) 1304.

The memory 1310 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory 1310 may incorporate electronic, magnetic, optical, and/or other types of storage media. In some embodiments, the memory 1310 can have a distributed architecture, where various storage devices are situated remotely from one another, but can be accessed by the processor 1308.

Software that is retained in the memory 1310 may include one or more software components, each of which can include an ordered listing of executable instructions for implementing logical functions. In the example of FIG. 13, the software in the memory 1310 of the server device 1302 can include one or more of the subsystems 1315 and an operating system (O/S) 1318. In some embodiments, the subsystems 1315 can include the service subsystem 442, the object recognition subsystem 210, and the verification subsystem 446.

Similarly, in the example of FIG. 13, the software in the memory 1310 of the client device 1306 can include one or more of the subsystems 1315 and a suitable operating system (0/S) 1318. In some embodiments, the subsystems 1315 in the client device 1306 can include the client subsystem 405 and the application that consumes customized digital content that can be supplied by the server device 1302. In other embodiments, the subsystems 1315 can include the application 295, including the object recognition subsystem 210 and the access control subsystem 220. The 0/S 1318 essentially controls the execution of other computer programs, such as the 0/S 1318, and provides scheduling, input-output control, file and data management, memory management, and communication control and related services.

For purposes of illustration, application programs and other executable program components such as the operating system 1318 are illustrated herein as discrete blocks, although it is recognized that such programs and components can reside at various times in different storage components of the server device 1302 and/or the client device 1306. An implementation of the subsystems 1315 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the technologies (e.g., techniques, computer program products, devices, and systems) of this disclosure have been described in connection with various embodiments and specific examples, it is not intended that the scope be limited to the particular embodiments put forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method, comprising:
receiving, by a computing system comprising at least one processor, imaging data from a mobile device, the imaging data represents an image of an object and is generated by the mobile device;
detecting, by the computing system, a group of defined markings on the image of the object, a first marking of the group of defined markings has specific semantics; and
selecting, by the computing system, a digital content based at least on the first marking.

2. The method of claim 1, further comprising validating the imaging data by the computing system prior to the detecting.

3. The method of claim 1, further comprising, determining, by the computing system, that a user account corresponding to the mobile device is configured to receive the digital content; and
sending, by the computing system, the digital content to the mobile device.

4. The method of claim 1, wherein the detecting comprises applying a machine-learning model to the image, the machine-learning model trained to identify the first marking of the defined markings.

5. The method of claim 1, further comprising receiving, by the computing system, second imaging data from the mobile device, the second imaging data represents an image of a three-dimensional (3D) solid;
validating the second imaging data by the computing system;
determining, by the computing system, that a form of the 3D solid corresponds to a defined form of a reference object; and
selecting, by the computing system, second digital content based at least on one or more of the form of the 3D solid, the mobile device, or the form of the 3D solid.

6. The method of claim 4, wherein the determining comprises, detecting geometrical features on the image of the 3D solid;
identifying the form of the 3D solid based at least on the one or more geometrical features; and
determining that the form of the 3D solid satisfies a matching criterion with respect to the defined form.

7. The method of claim 6, wherein the identifying comprises applying a machine-learning shape model to the one or more geometrical features.

8. A system, comprising:
at least one memory device having instructions stored thereon; and
at least one processor functionally coupled to the at least one memory device and configured to execute the instructions at least to
receive imaging data from a mobile device, the imaging data represents an image of an object and is generated by the mobile device;
detect a group of defined markings on the image of the object, a first marking of the group of defined markings has specific semantics; and
select digital content based at least on one or more of the first marking.

9. The system of claim 8, the at least one processor further configured to execute the instructions to validate the imaging data by the computing system prior to the detecting.

10. The system of claim 8, the at least one processor further configured to execute the instructions to,
determine that a user account corresponding to the mobile device is configured to receive the media assert; and
send the digital content to the mobile device.

11. The system of claim 8, wherein to detect the group of defined markings, the at least one processor further configured to execute the instructions to apply a machine-learning model to the image, the machine-learning model trained to identify the first marking of the defined markings.

12. The system of claim 8, the at least one processor further configured to receive second imaging data from the mobile device, the second imaging data represents an image of a three-dimensional (3D) solid;
validate the second imaging data by the computing system;
determine that a form of the 3D solid corresponds to a defined form of a reference object; and
select second digital content based at least on the form of the 3D solid.

13. The system of claim 12, wherein to determine that the form of the 3D object corresponds to the defined form of the reference object, the at least one processor further configured to,
detect geometrical features on the image of the 3D solid;
identify the form of the 3D solid based at least on the one or more geometrical features; and
determine that the form of the 3D solid satisfies a matching criterion with respect to the defined form.

14. The system of claim 14, wherein to identify the form, the at least one processor is further configured to execute the instructions to apply a machine-learning shape model to the one or more geometrical features.

15. At least one computer-readable storage device having instructions stored thereon that, in response to execution, cause a computing system to perform or facilitate operations comprising:
receiving imaging data from a mobile device, the imaging data represents an image of an object and is generated by the mobile device;
detecting a group of defined markings on the image of the object, a first marking of the group of defined markings has specific semantics; and
selecting a digital content based at least on the first marking.

16. The at least one computer-readable storage device of claim 15, the operations further comprising,
determining that a user account corresponding to the mobile device is configured to receive the digital content; and
sending, by the computing system, the digital content to the mobile device.

17. The at least one computer-readable storage device of claim 15, wherein the detecting comprises applying a machine-learning model to the image, the machine-learning model trained to identify the first marking of the defined markings.

18. The at least one computer-readable storage device of claim 15, further comprising,
receiving, second imaging data from the mobile device, the second imaging data represents an image of a three-dimensional (3D) solid;
validating the second imaging data by the computing system;
determining that a form of the 3D solid corresponds to a defined form of a reference object; and
selecting second digital content based at least on the form of the 3D solid.

19. The at least one computer-readable storage device of claim 18, wherein the determining comprises, detecting geometrical features on the image of the 3D solid;
identifying the form of the 3D solid based at least on the one or more geometrical features; and
determining that the form of the 3D solid satisfies a matching criterion with respect to the defined form.

20. The at least one computer-readable storage device of claim 19, wherein the identifying comprises applying a machine-learning shape model to the one or more geometrical features.
